(19) United States
(12) Patent Application Publication
(10) Pub. No.: US 2013/0047878 A1
(43) Pub. Date: Feb. 28, 2013

(54) RESIN COMPOSITION FOR LASER ENGRAVING, RELIEF PRINTING PLATE PRECURSOR FOR LASER ENGRAVING AND PROCESS FOR PRODUCING SAME, PROCESS FOR MAKING RELIEF PRINTING PLATE, AND RELIEF PRINTING PLATE

(71) Applicant: Yousuke MATSUMOTO, Haibara-gun (JP)

(72) Inventor: Yousuke MATSUMOTO, Haibara-gun (JP)

(73) Assignee: FUJIFILM CORPORATION, Tokyo (JP)

(21) Appl. No.: 13/599,700

(22) Filed: Aug. 30, 2012

(30) Foreign Application Priority Data
Aug. 31, 2011 (JP) 2011-189871

(51) Int. Cl. C09D 171/00; B41N 1/00; C08J 3/24; B29C 59/16; C09D 133/08; C08J 3/28

(52) U.S. Cl. 101/395; 524/593; 524/560; 522/126; 522/146; 264/400

(57) ABSTRACT

Disclosed is a resin composition for laser engraving comprising: (Component A) a compound represented by following Formula (1), and (Component B) a binder polymer having a functional group that is capable of reacting with a hydrolyzable silyl group and/or a silanol group and thereby forming a crosslinked structure:

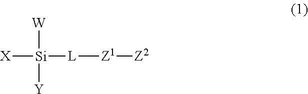

wherein W, X and Y each independently represent a hydrolyzable group or a hydroxy group; L represents a divalent linking group or a single bond; Z¹ represents a divalent group having 4 to 45 carbon atoms in total and containing at least two of a unit selected from an ethylene oxide unit and a propylene oxide unit; Z² represents an alkyl group having 7 or less carbon atoms, or a benzyl group; and the sum of the numbers of carbon atoms of L, Z¹ and Z² is 10 to 50.

### TECHNICAL FIELD

The present invention relates to a resin composition for laser engraving, a relief printing plate precursor for laser engraving and a process for producing same, a process for making a relief printing plate, and a relief printing plate.

### BACKGROUND ART

As a process for forming a printing plate by forming asperities in a photosensitive resin layer layered on a support surface area, a method in which a relief-forming layer formed using a photosensitive composition is exposed to UV light through an original image film to thus selectively cure an image area, and an uncured area is removed using a developer, the so-called ‘analogue plate making’, is well known.

A relief printing plate is a letterpress printing plate having a relief layer with asperities, and such a relief layer with asperities is obtained by patterning a relief-forming layer comprising a photosensitive composition containing as a main component, for example, an elastomeric polymer such as a synthetic rubber, a resin such as a thermoplastic resin, or a mixture of a resin and a plasticizer, thus forming asperities. Among such relief printing plates, one having a soft relief layer is sometimes called a flexographic plate.

When a relief printing plate is made by analogue plate making, since an original image film employing a silver salt material is generally necessary, production time and cost for the original image film are incurred. Furthermore, since development of the original image film requires a chemical treatment, and treatment of development effluent is required, simpler plate making methods, for example, a method that does not use an original image film, a method that does not require development processing, etc. have been examined.

As a plate making process that does not require a development process, many of the so-called ‘direct engraving CTP methods’, in which a relief-forming layer is directly engraved by means of a laser, have been proposed. The direct engraving CTP method is a method in which relief-forming asperities are formed by engraving by means of the laser itself, and has the advantage that, unlike relief formation using an original image film, the relief shape can be freely controlled. Consequently, when such image as an outline character is to be formed, it is also possible to engrave that region deeper than other regions, or, in the case of a fine halftone dot image, it is possible, taking into consideration resistance to printing pressure, to engrave while adding a shoulder.

JP-A-2011-51273 describes a resin composition for laser engraving containing a plasticizer having a specific structural formula and a binder polymer having a hydrophilic group.

Furthermore, JP-A-2011-102027 describes a resin composition for laser engraving containing (A) a compound having at least one of a hydrolyzable silyl group and a silanol group, and (B) a binder polymer having a functional group that is capable of reacting with at least one of a hydrolyzable silyl group and a silanol group and forming a crosslinked structure.

### SUMMARY OF INVENTION

It is an object of the present invention to provide a relief printing plate precursor for laser engraving having excellent solvent resistance, and a resin composition for laser engraving which can yield the relief printing plate precursor for laser engraving. Furthermore, it is another object of the present invention to provide a method for producing a relief printing plate precursor for laser engraving, a method for making a relief printing plate, and a relief printing plate.

The objects of the present invention were solved by the means described in the following <1>, <13>, <14>, <15>, <17> and <18>. Preferable embodiments as described in <2> to <12>, <16>, <19> and <20> will also be described below.

<1> A resin composition for laser engraving comprising (Component A) a compound represented by following Formula (1), and (Component B) a binder polymer having a functional group that is capable of reacting with a hydrolyzable silyl group and/or a silanol group and thereby forming a crosslinked structure:

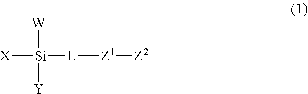

wherein in Formula (1), W, X and Y each independently represent a hydrolyzable group selected from the group consisting of an alkoxy group, an aryloxy group, a mercapto group, a halogen atom, an amide group, an acetoxy group, an amino group and an isopropenoxy group, or a hydroxy group; L represents a divalent linking group or a single bond; Z¹ represents a divalent group having 4 to 45 carbon atoms in total and containing at least two of a unit selected from an ethylene oxide unit and a propylene oxide unit; Z² represents an alkyl group having 7 or less carbon atoms, or a benzyl group; and the sum of the numbers of carbon atoms of L, Z¹ and Z² is 10 to 50;

<2> the resin composition for laser engraving as described in <1>, wherein the melting point at 1 atm of the compound represented by Formula (1) is 25° C. or lower;

<3> the resin composition for laser engraving as described in <1> or <2>, wherein in Formula (1), L represents a divalent linking group having, in the structure, at least one selected from the group consisting of an ester bond, a thioester bond, a thionoester bond, an amide bond, a carbonyl group, a thiocarbonyl group, an ether bond, a thioether bond, —NR¹— (wherein R¹ represents a hydrogen atom, or an alkyl group having 1 to 4 carbon atoms), and —N═CR²— (wherein R² represents a hydrogen atom or an alkyl group having 1 to 4 carbon atoms);

<4> the resin composition for laser engraving as described in any one of <1> to <3>, wherein in Formula (1), L represents a divalent linking group having, in the structure, at least one selected from the group consisting of an ester bond, a thioester bond, a thionoester bond, an amide bond, a carbonyl group, and a thiocarbonyl group, and at least one selected from the group consisting of an ether bond, a thioether bond, —NR¹— (wherein R¹ represents a hydrogen atom or an alkyl group having 1 to 4 carbon atoms), and —N═CR²— (wherein R² represents a hydrogen atom or an alkyl group having 1 to 4 carbon atoms);

<5> the resin composition for laser engraving as described in any one of <1> to <4>, wherein in Formula (1), L represents L¹-L²-L³; L¹ represents an alkylene group or a divalent linking group having at least one selected from the group consisting of −O—, —S—, —NR¹— (wherein R¹ represents a hydrogen atom or an alkyl group having 1 to 4 carbon atoms), and —N═CR²— (wherein R² represents a hydrogen atom or an alkyl group having 1 to 4 carbon atoms); L² represents a divalent linking group having at least one selected from the group consisting of an ester bond, a thioester bond, a thionoester bond, an amide bond, a carbonyl group, and a thiocarbonyl group; and L³ represents a single bond or a group selected from the group consisting of a methylene group, an ethylene group and a propylene group;

<6> the resin composition for laser engraving as described in any one of <1> to <5>, wherein Component A has a content of 10 wt % to 40 wt % relative to the weight of the solids content of the resin composition for laser engraving;

<7> the resin composition for laser engraving as described in any one of <1> to <6>, further comprising (Component C) a silane coupling agent;

<8> the resin composition for laser engraving as described in any one of <1> to <7>, further comprising (Component D) a photothermal conversion agent;

<9> the resin composition for laser engraving as described in any one of <1> to <8>, wherein the functional group that is capable of reacting with a hydrolyzable silyl group and/or a silanol group and forming a crosslinked structure in (Component B) the binder polymer, is selected from the group consisting of a hydroxy group, an alkoxy group, a silanol group, and a hydrolyzable silyl group;

<10> the resin composition for laser engraving as described in any one of <1> to <9>, wherein (Component B) the binder polymer is an acrylic resin and/or polyvinyl butyral;

<11> the resin composition for laser engraving as described in any one of <1> to <10>, further comprising (Component E) an alcohol exchange reaction catalyst;

<12> the resin composition for laser engraving as described in any one of <1> to <11>, further comprising (Component F) a polymerizable compound, and (Component G) a polymerization initiator;

<13> a relief printing plate precursor for laser engraving, comprising a relief-forming layer formed from the resin composition for laser engraving as described in any one of <1> to <12>;

<14> a relief printing plate precursor for laser engraving comprising a crosslinked relief-forming layer formed by crosslinking a relief-forming layer formed from the resin composition for laser engraving as described in any one of <1> to <12>, by means of light and/or heat;

<15> a method for producing a relief printing plate precursor for laser engraving, the method comprising a layer forming step of forming a relief-forming layer formed from the resin composition for laser engraving as described in any one of <1> to <12>; and a crosslinking step of crosslinking the relief-forming layer by means of light and/or heat to obtain a relief printing plate precursor having a crosslinked relief-forming layer;

<16> the method for producing a relief printing plate precursor for laser engraving as described in <15>, wherein the crosslinking step is a step of crosslinking a layer of the resin composition for laser engraving by means of heat, and thereby obtaining a relief printing plate precursor having a relief-forming layer;

<17> a method for making a relief printing plate, the method comprising a step of obtaining a relief printing plate precursor having a crosslinked relief-forming layer that is obtainable by crosslinking a relief-forming layer formed from the resin composition for laser engraving as described in any one of <1> to <12> by means of light and/or heat; and a step of laser-engraving the crosslinked relief-forming layer of the relief printing plate precursor;

<18> a relief printing plate comprising a relief layer made by the method for making a relief printing plate as described in <17>;

<19> the relief printing plate as described in <18>, wherein the thickness of the relief layer is at least 0.05 mm but no greater than 10 mm; and

<20> the relief printing plate as described in <18> or <19>, wherein the Shore A hardness of the relief layer is at least 50° but not greater than 90°.

### DESCRIPTION OF EMBODIMENTS

### 1. Resin Composition for Laser Engraving

A resin composition for laser engraving of the present invention comprises (Component A) a compound represented by following Formula (1), and (Component B) a binder polymer having a functional group that is capable of reacting with a hydrolyzable silyl group and/or a silanol group and thereby forming a crosslinked structure.

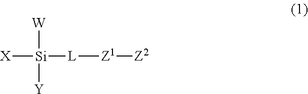

(In Formula (1), W, X and Y each independently represent a hydrolyzable group selected from the group consisting of an alkoxy group, an aryloxy group, a mercapto group, a halogen atom, an amide group, an acetoxy group, an amino group and an isopropenoxy group, or a hydroxy group; L represents a divalent linking group or a single bond; Z¹ represents a divalent group having 4 to 45 carbon atoms in total and containing at least two of a unit selected from an ethylene oxide unit and a propylene oxide unit; Z² represents an alkyl group having 7 or less carbon atoms, or a benzyl group; and the sum of the numbers of carbon atoms of L, Z¹ and Z² is 10 to 50.

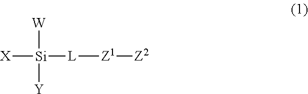

With regard to embodiments of application of the resin composition for laser engraving of the present invention, specific examples include, but are not limited to, an image-forming layer of an image-forming material that is subjected to image formation by laser engraving, a relief-forming layer of a printing plate precursor that is subjected to raised relief formation by laser engraving, an intaglio plate, a stencil plate, and a stamp.

The resin composition for laser engraving of the present invention may comprise other components in addition to the above-mentioned components.

In the present invention, the notation ‘A to B’, which expresses a numerical range, means ‘at least A but no greater than B’ or ‘no greater than A but at least B. That is, they are numerical ranges that include A and B which are end points. “(Component A) a compound represented by Formula (1)” etc. are simply called “Component A” etc.

The compounds used in the resin composition for laser engraving are explained below.

(Component A) Compound represented by Formula (1)

The resin composition for laser engraving of the present invention comprises a compound represented by Formula (1) below.

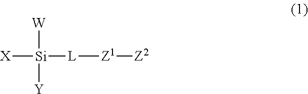

(In Formula (1), W, X and Y each independently represent a hydrolyzable group selected from the group consisting of an alkoxy group, an aryloxy group, a mercapto group, a halogen atom, an amide group, an acetoxy group, an amino group and an isopropenoxy group, or a hydroxy group; L represents a divalent linking group or a single bond; Z¹ represents a divalent group having 4 to 45 carbon atoms in total and containing at least two of a unit selected from an ethylene oxide unit and a propylene oxide unit; Z² represents an alkyl group having 7 or less carbon atoms, or a benzyl group; and the sum of the numbers of carbon atoms of L, Z¹ and Z² is 10 to 50.)

In Formula (1), W, X and Y independently represents a hydrolyzable group selected from the group consisting of an alkoxy group, an aryloxy group, mercapto group, a halogen atom, an amide group, an acetoxy group, an amino group and an isopropenoxy group, or hydroxy group. As W, X, and Y, a halogen atom or an alkoxy group is preferable and an alkoxy group is preferably preferable.

Examples of the halogen atom include a fluorine (F) atom, a chlorine atom (Cl) and a bromine (Br) atom, and a more preferred example is a Cl atom.

From the viewpoint of rinsability and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, and particularly preferably an alkoxy group having 1 to 3 carbon atoms.

Examples of the alkoxy group include a methoxy group, an ethoxy group, a propoxy group, an isopropoxy group, a butoxy group, a tert-butoxy group, and a benzyloxy group. Examples of the alkoxysilyl group having an alkoxy group bonded thereto include a trialkoxysilyl group such as a trimethoxysilyl group, a triethoxysilyl group, a triisopropoxysilyl group. A plurality of different alkoxy groups may be used in combination.

Examples of the aryloxy group include phenoxy group. Examples of the aryloxysilyl group having an aryloxy group bonded thereto include a triarylsilyl group such as a triphenylsilyl group.

W, X and Y may be identical to or different from with each other, but from the viewpoint of synthetic suitability, it is preferable that W, X and Y be identical.

In Formula (1), L represents a divalent linking group or a single bond. The divalent linking group represented by L is preferably a divalent linking group having, in the structure (in the molecular chain), at least one selected from the group consisting of an ester bond (—C(═O)—O—), a thioester bond (—C(═O)—S—), a thionoester bond (—C(═S)—O—), an amide bond (—C(═O)—NR—), wherein R represents a hydrogen atom or a monovalent substituent, and is preferably a hydrogen atom or an alkyl group having 1 to 4 carbon atoms), a carbonyl group (—(C═O)—), a thiocarbonyl group (—(C═S)—), an ether bond (—OA a thioether bond (—S—), —NR¹— (wherein R¹ represents a hydrogen atom or an alkyl group having 1 to 4 carbon atoms), and —N═CR²— (wherein R² represents a hydrogen atom or an alkyl group having 1 to 4 carbon atoms).

Furthermore, L is more preferably a divalent linking group having, the structure, at least one selected from the group consisting of an ester bond, a thioester bond, a thionoester bond, an amide bond, a carbonyl group and a thiocarbonyl group, and at least one selected from the group consisting of an ether bond, a thioether bond, —NR¹— (wherein R¹ represents a hydrogen atom or an alkyl group having 1 to 4 carbon atoms), and —N═CR²— (wherein R² represents a hydrogen atom or an alkyl group having 1 to 4 carbon atoms).

L is yet more preferably a divalent linking group having, in the structure, an ester bond and at least one selected from the group consisting of an ether bond, a thioether bond, and —NR¹— (wherein R¹ represents a hydrogen atom or an alkyl group having 1 to 4 carbon atoms).

In Formula (1), *-L-** preferably represents *-L¹-L²-L³-**. Meanwhile, represents the bonding position to a silicon atom, and ** represents the bonding position to Z¹. L¹ represents an alkylen group or a divalent linking group having at least one selected from the group consisting of an ether bond (—O—), a thioether bond (—S—), —NR¹— (wherein R¹ represents a hydrogen atom or an alkyl group having 1 to 4 carbon atoms), and —N═CR²— (wherein R² represents a hydrogen atom or an alkyl group having 1 to 4 carbon atoms). L² represents a divalent linking group having at least one selected from the group consisting of an ester bond (—C(═O)—O—), a thioester bond (—C(═O)—S—), a thionoester bond (—C(═S)—O—), an amide bond (—C(═O)—NR—), wherein R represents a hydrogen atom or an alkyl group having 1 to 4 carbon atoms), a carbonyl group (—C(═O)—), and a thiocarbonyl group (—C(═S)—). L³ is selected from the group consisting of a single bond, a methylene group, an ethylene group and a propylene group.

Among these, L¹ is preferably a divalent linking group having 3 to 6 carbon atoms and having, in the alkylene chain, one group or bond selected from the group consisting of an ether bond (—O—), a thioether bond (—S—), —NR¹— (wherein R¹ represents a hydrogen atom or an alkyl group having 1 to 4 carbon atoms), and —N═CR²— (wherein R² represents a hydrogen atom or an alkyl group having 1 to 4 carbon atoms), and preferably a divalent linking group having 3 to 6 carbon atoms and having, in the alkylene chain, one group or bond selected from the group consisting of an ether bond (—O—), a thioether bond (—S—), and —NR^{S}— (wherein R¹ represents a hydrogen atom or an alkyl group having 1 to 4 carbon atoms). Meanwhile, the alkylene chain may be linear or branched, or may form a ring, without any particular limitations.

L² is preferably a divalent linking group selected from the group consisting of an ester bond (—C(═O)—O—), a thioester bond (—C(═O)—S—), a thionoester bond (—C(═S)—O—), an amide bond (—C(═O)—NR—), wherein R represents a hydrogen atom or an alkyl group having 1 to 4 carbon atoms), a carbonyl group (—C(═O)—) and a thiocarbonyl group (—C(═S)—), and is more preferably a divalent linking group selected from the group consisting of an ester bond (—C(═O)—O—), a thioester bond (—C(═O)—S—) and a thionoester bond (—C(═S)—O—).

L³ is preferably a single bond.

Z¹ represents a divalent group containing at least two of a unit selected from an ethylene oxide unit and a propylene oxide unit and having 4 to 45 carbon atoms in total. Z¹ may comprise an ethylene oxide unit only, may comprise a propylene oxide unit only, or may comprise both. The total number of carbon atoms of Z¹ is 4 to 45, preferably 6 to 30, and more preferably 8 to 24.

Furthermore, the propylene oxide unit may be linear or may be branched.

Z² represents an alkyl group having 7 or fewer carbon atoms or a benzyl group, and is preferably an alkyl group having 1 to 6 carbon atoms or a benzyl group, more preferably an alkyl group having 1 to 3 carbon atoms or a benzyl group, and yet more preferably a methyl group, an ethyl group, or a benzyl group.

The sum of the numbers of carbon atoms of L, Z¹ and Z² is 10 to 50. If the sum of the numbers of carbon atoms is less than 10, sufficient plasticity cannot be exhibited. Furthermore, if the sum of the numbers of carbon atoms is more than 50, compatibility with Component B may be poor. The sum of the numbers of carbon atoms is preferably 12 to 48, more preferably 16 to 42, and yet more preferably 18 to 36.

According to the present invention, the compound represented by Formula (1) has only one silicon atom that is bonded to a hydrolyzable group and/or a hydroxy group. When the compound has only one silicon atom that is bonded to a hydrolyzable group and/or a hydroxy group, it is preferable because the flexibility of the relief layer, obtainable as L-Z¹-Z² is extended from the crosslinked structure in a side chain form, is further enhanced.

Preferred examples of the compound represented by Formula (1) include the following compound (1-1) to compound (1-19), but the present invention is not limited to these. Meanwhile, according to the present invention, the chemical formulae may be described based on simple structural formulae, and particularly, solid lines without any mention of elements or substituents represent hydrocarbon groups. Furthermore, in the specific examples described below, Me represents a methyl group, Et represents an ethyl group, Prⁱ represents an isopropyl group, and Bn represents a benzyl group.

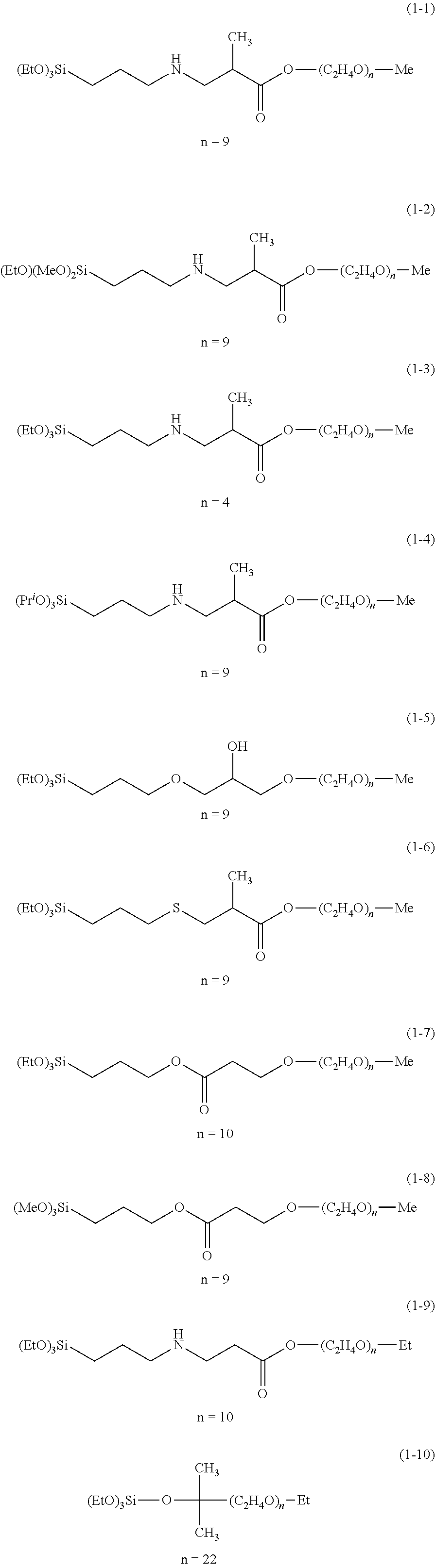

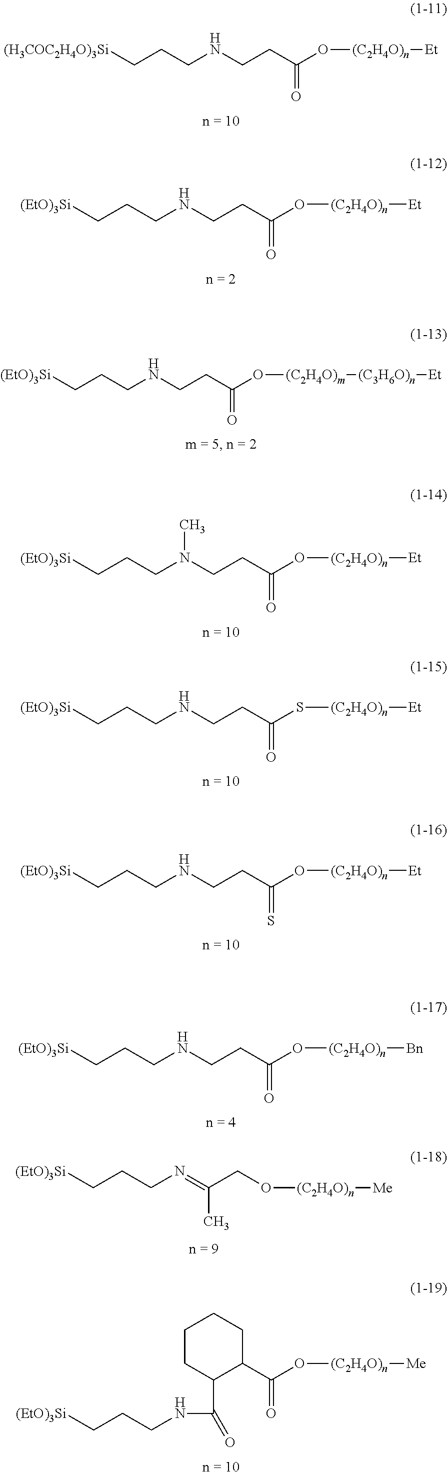

In addition, what are respectively represented by Compound (1-1) to Compound (1-19) when L represents L¹-L²-L³ as discussed above, are indicated in the following table. Meanwhile, in Compound (1-5), Compound (1-10) and Compound (1-18), L represents a divalent linking group having, in the structure, at least one selected from the group consisting of an ester bond, a thioester bond, a thionoester bond, an amide bond, a carbonyl group, a thiocarbonyl group, an ether bond, a thioether bond, —NR¹— (wherein R¹ represents a hydrogen atom or an alkyl group having 1 to 4 carbon atoms), and —N═CR²— (wherein R² represents a hydrogen atom or an alkyl group having 1 to 4 carbon atoms). More specifically, in Compound (1-5) and Compound (1-10), L represents a divalent linking group having an ether bond, and in Compound (1-18), L represents a divalent linking group having —N═CR²— (wherein R² represents a methyl group).

| Compound | L¹ | L² | L³ |
|---|---|---|---|
| (1-1) | —(CH₂)₃—NH—CH₂—CH(CH₃)— | —C(═O)—O— | single bond |
| (1-2) | —(CH₂)₃—NH—CH₂—CH(CH₃)— | —C(═O)—O— | single bond |
| (1-3) | —(CH₂)₃—NH—CH₂—CH(CH₃)— | —C(═O)—O— | single bond |
| (1-4) | —(CH₂)₃—NH—CH₂—CH(CH₃)— | —C(═O)—O— | single bond |
| (1-5) | — | | |
| (1-6) | —(CH₂)₃—S—CH₂—CH(CH₃)— | —C(═O)—O— | single bond |
| (1-7) | —(CH₂)₃— | —C(═O)—O— | single bond |
| (1-8) | —(CH₂)₃— | —O—C(═O)— | single bond |
| (1-9) | —(CH₂)₃—NH—(CH₂)₂— | —C(═O)—O— | single bond |
| (1-10) | — | | |
| (1-11) | —(CH₂)₃—NH—(CH₂)₂— | —C(═O)—O— | single bond |
| (1-12) | —(CH₂)₃—NH—(CH₂)₂— | —C(═O)—O— | single bond |
| (1-13) | —(CH₂)₃—NH—(CH₂)₂— | —C(═O)—O— | single bond |
| (1-14) | —(CH₂)₃—N(CH₃)—(CH₂)₂— | —C(═O)—O— | single bond |
| (1-15) | —(CH₂)₃—NH—(CH₂)₂— | —C(═O)—S— | single bond |
| (1-16) | —(CH₂)₃—NH—(CH₂)₂— | —C(═S)—O— | single bond |
| (1-17) | —(CH₂)₃—NH—(CH₂)₂— | —C(═O)—O— | single bond |
| (1-18) | — | | |
| (1-19) | —(CH₂)₃—NH— | —C(═O)-(cyclohexane-1,2-diyl)-C(═O)—O— | single bond |

Among these, Compounds (1-1), (1-3), (1-4), (1-6), (1-8), (1-9), and (1-13) are preferred, Compounds (1-1), (1-6), (1-8), and (1-9) are more preferred, and Compound (1-6) is yet more preferred.

The melting point at 1 atm of (Component A) the compound represented by Formula (1) is preferably 25° C. or lower, more preferably −15° C. to 10° C., and yet more preferably −15° C. to 0° C. When the melting point of Component A is in the range described above, it is preferable because the relief layer thus obtained has excellent flexibility.

The melting point of Component A can be measured according to JIS K-0065 for the range of −15° C. to 100° C.

Component A may be used individually, or two or more kinds may be used in combination.

The content of Component A in the resin composition is preferably 1 wt % to 50 wt %, more preferably 5 wt % to 40 wt %, and yet more preferably 10 wt % to 30 wt %, relative to the weight of the solids content. When the content of Component A is in the range described above, it is preferable because the resin composition has excellent solvent resistance. (Component B) Binder polymer having a functional group that is capable of reacting with a hydrolyzable silyl group and/or a silanol group and thereby forming a crosslinked structure

The resin composition for laser engraving of the present invention comprises (Component B) a binder polymer having a functional group that is capable of reacting with a hydrolyzable silyl group and/or a silanol group and forming a crosslinked structure. When Component B reacts with Component A and forms a crosslinked structure, a resin composition for laser engraving which can form a printing plate having excellent solvent resistance is provided.

The reactive functional group that is capable of reacting with a hydrolyzable silyl group and/or a silanol group is not particularly limited as long as it is a group which is capable of reacting with at least one of a hydrolyzable silyl group and a silanol group carried by Component A and forming a —Si—O— bond, and a hydroxy group, an alkoxy group, a silanol group, and a hydrolyzable silyl group are preferably used.

These functional groups may be present at any site of the polymer molecule, but it is particularly preferable that the functional groups be present on the side chains of the polymer chain. As such a polymer, a vinyl copolymer (a copolymer of a vinyl monomer such as polyvinyl alcohol or polyvinyl acetal, or a derivative thereof), or an acrylic resin (a copolymer of an acrylic monomer such as hydroxyethyl (meth)acrylate, or a derivative thereof) is preferably used. Here, a derivative of a copolymer of a vinyl monomer specifically means a binder polymer in which the OH group of a vinyl alcohol unit or the α-position of the OH group is chemically modified to obtain a form having an extended side chain, and a functional group which is capable of reacting with Component A such as an OH group or a carboxyl group is introduced into the chain end. Furthermore, an example of a derivative of a copolymer of an acrylic based monomer may be a resin having a functional group which reacts with Component A such as an OH group or a carboxyl group.

There are no particular limitations on the method for producing Component B that can be used in the present invention, but a method for producing Component B by polymerizing or copolymerizing a polymerizable monomer which has a group that is capable of reacting with at least any of a hydrolyzable silyl group and a silanol group and forming a crosslinked structure, may be used.

As such Component B, in particular, (Component B-1) a binder polymer having a hydroxy group is preferably used.

### (Component B-1) Binder Polymer Having a Hydroxy Group

Hereinafter, (Component B-1) a binder polymer having a hydroxy group (hereinafter, appropriately also referred to as a “(Component B-1) specific polymer”) will be explained. This binder polymer is preferably insoluble in water and soluble in alcohol having 1 to 4 carbon atoms.

As (Component B-1) a specific polymer, from the viewpoint of satisfying both good durability properties for an aqueous ink and for a UV ink, and having a high engraving sensitivity and good film performance, polyvinyl butyral (PVB) and derivatives thereof, acrylic resins having a hydroxy group on a side chain, epoxy resins having a hydroxy group on a side chain, etc. are preferable.

Since improvement of engraving sensitivity can be obtained when combined with a photothermal conversion agent which is a preferable co-component for forming a resin composition for laser engraving of the present invention described below, it is particularly preferable that (Component B-1) a specific polymer used in the present invention have a glass transition temperature (Tg) of at least 20° C. A binder polymer having such a glass transition temperature is also called a non-elastomer below. That is, generally, an elastomer is academically defined as a polymer having a glass transition temperature of no greater than 20° C. (room temperature) (ref. Kagaku Dai Jiten 2nd edition (Science Dictionary), Foundation for Advancement of International Science, Maruzen, page 154). Non-elastomer refers to a polymer which has a glass transition temperature of greater than room temperature. The upper limit for the glass transition temperature of the polymer is not limited, but is preferably no greater than 200° C. from the viewpoint of ease of handling, and is more preferably at least 25° C. but no greater than 120° C.

When a polymer having a glass transition temperature of room temperature (20° C.) or greater is used, (Component B-1) a specific polymer is in a glass state at normal temperature. Because of this, compared with a case of the rubber state, thermal molecular motion is largely suppressed. In laser engraving, in addition to the heat given by a laser during laser irradiation, heat generated by the function of a photothermal conversion agent added as desired is transmitted to the surrounding (Component B-1) the specific polymer, and this polymer is thermally decomposed and disappears, thereby forming an engraved recess.

According to the preferred embodiment of the present invention, when the photothermal conversion agent is present in (Component B-1) the specific polymer in a state in which thermal molecular motion is suppressed, it is surmised that heat transfer to (Component B-1) the specific polymer and heat decomposition might occur effectively. Because of that, it is surmised that engraving sensitivity is further improved.

Specific examples of (Component B-1) the specific polymer that is non-elastomer preferably used in the present invention are cited below.

### (1) Polyvinyl Acetal Derivative

In the present specification, hereinafter, polyvinyl acetal and derivatives thereof will be simply referred to as polyvinyl acetal derivatives. That is, the term “polyvinyl acetal derivatives” in the present specification is used as a concept including polyvinyl acetal and derivatives thereof, and indicates a generic name for compounds obtainable by cyclic acetalization of polyvinyl alcohol (obtainable by saponifying polyvinyl acetate).

The acetal content in the polyvinyl acetal derivative (mole % of vinyl alcohol units converted into acetal relative to the total number of moles of vinyl acetate monomer starting material as 100 mole %) is preferably 30 to 90 mole %, more preferably 50 to 85 mole %, and particularly preferably 55 to 78 mole %.

The vinyl alcohol unit in the polyvinyl acetal is preferably 10 to 70 mole % relative to the total number of moles of the vinyl acetate monomer starting material, more preferably 15 to 50 mole %, and particularly preferably 22 to 45 mole %.

Furthermore, the polyvinyl acetal derivative may have a vinyl acetate unit as another component, and the content thereof is preferably 0.01 to 20 mole %, and more preferably 0.1 to 10 mole %. The polyvinyl acetal derivative may further have another copolymerized constitutional unit.

Examples of the polyvinyl acetal derivative include polyvinyl butyral derivative, polyvinyl propylal derivative, polyvinyl ethylal derivative, and polyvinyl methylal derivative. Among them, polyvinyl butyral derivative (PVB) is particularly preferably used.

Meanwhile, in these descriptions, for example, the term “polyvinyl butyral derivatives” is used in the present specification to mean to include polyvinyl butyral and derivatives thereof, and the same also applies to other polyvinyl acetal derivatives.

From the viewpoint of a balance being achieved between engraving sensitivity and film formation properties, the weight-average molecular weight of the polyvinyl acetal is preferably 5,000 to 800,000, more preferably 8,000 to 500,000 and, from the viewpoint of improvement of rinsing properties for engraved residue, particularly preferably 50,000 to 300,000.

Hereinafter, polyvinyl butyral (PVB) and derivatives thereof are cited for explanation as particularly preferred examples of polyvinyl acetal, but the polyvinyl acetal are not limited to these.

Polyvinyl butyral has a structure as shown below, and is constituted while including these structural units.

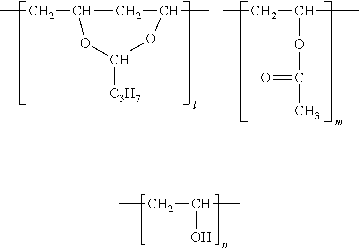

Derivatives of PVB are available as a commercial product. As specific examples, from the viewpoint of alcohol (in particular, ethanol) solubility, “Eslec B” series and “Eslec K (KS)” series (Sekisui Chemical Co., Ltd.) and “Denka Butyral” (Denki Kagaku Kogyo Kabushiki Kaisha) are preferable, and, from the viewpoint of alcohol (in particular, ethanol) solubility, “Eslec B” series (Sekisui Chemical Co., Ltd.) and “Denka Butyral” (Denki Kagaku Kogyo Kabushiki Kaisha) are more preferable.

Among these, particularly preferable commercial products are shown below with values of l, m and n in Formula above and molecular weight. With regard to “Eslec B” series (Sekisui Chemical Co., Ltd.), “BL-1” (l=61, m=3, n=36, weight average molecular weight: 19,000), “BL-1H” (l=67, m=3, n=30, weight average molecular weight: 20,000), “BL-2” (l=61, m=3, n=36, weight average molecular weight: about 27,000), “BL-5” (l=75, m=4, n=21, weight average molecular weight: 32,000), “BLS” (l=74, m=4, n=22, weight average molecular weight: 23,000), “BM-S” (l=73, m=5, n=22, weight average molecular weight: 53,000), “BH-S” (l=73, m=5, n=22, weight average molecular weight: 66,000) are cited. With regard to “Denka Butyral” series (Denki Kagaku Kougyo Kabushiki Kaisha), “#3000-1” (l=71, m=1, n=28, weight average molecular weight: 74,000), “#3000-2” (l=71, m=1, n=28, weight average molecular weight: 90,000), “#3000-4” (l=71, m=1, n=28, weight average molecular weight: 117,000), “#4000-2” (1=71, m=1, n=28, weight average molecular weight: 152,000), “#6000-C” (l=64, m=1, n=35, weight average molecular weight: 308,000), “#6000-EP” (l=56, m=15, n=29, weight average molecular weight: 381,000), “#6000-CS” (l=74, m=1, n=25, weight average molecular weight: 322,000), “#6000-AS” (l=73, m=1, n=26, weight average molecular weight: 242,000) are cited.

When the relief-forming layer is formed using PVB as (Component B-1) the specific polymer, a method of casting and drying a solution prepared by solving it in a solvent is preferable from the viewpoint of the flatness of the film surface.

### (2) An Acrylic Resin

As acrylic resin for use as (Component B-1) the specific polymer of the present invention, an acrylic resin may be used which can be obtained from known acrylic monomers and has a hydroxy group in the molecule.

Preferable examples of the acrylic monomer having a hydroxy group which can be used for synthesis of the acrylic resin having a hydroxy group include a (meth)acrylic acid ester, a crotonic acid ester, or a (meth)acrylamide that has a hydroxy group in the molecule. Specific examples of such a monomer include 2-hydroxyethyl (meth)acrylate, 2-hydroxypropyl (meth)acrylate, and 4-hydroxybutyl (meth)acrylate.

As acrylic resin, the acrylic monomer other than that having hydroxy group may be comprised as a co-monomer. Examples thereof such an acrylic monomer include, as the (meth)acrylic ester, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, lauryl (meth)acrylate, 2-ethylhexyl (meth)acrylate, acetoxyethyl (meth)acrylate, phenyl (meth)acrylate, 2-methoxyethyl (meth)acrylate, 2-ethoxyethyl (meth)acrylate, 2-(2-methoxyethoxy)ethyl (meth)acrylate, cyclohexyl (meth)acrylate, t-butylcyclohexy (meth)acrylate, benzyl (meth)acrylate, diethylene glycol monomethyl ether (meth)acrylate, diethylene glycol monoethyl ether (meth)acrylate, diethylene glycol monophenyl ether (meth)acrylate, triethylene glycol monomethyl ether (meth)acrylate, triethylene glycol monoethyl ether (meth)acrylate, dipropylene glycol monomethyl ether (meth)acrylate, polyethylene glycol monomethyl ether (meth)acrylate, polypropylene glycol monomethyl ether (meth)acrylate, the monomethyl ether (meth)acrylate of a copolymer of ethylene glycol and propylene glycol, N,N-dimethylaminoethyl (meth)acrylate, N,N-diethylaminoethyl (meth)acrylate, and N,N-dimethylaminopropyl (meth)acrylate.

Furthermore, a modified acrylic resin formed with a urethane group- or urea group-containing acrylic monomer may preferably be used.

Among these, from the viewpoint of aqueous ink resistance, an alkyl (meth)acrylate such as lauryl (meth)acrylate and an aliphatic cyclic structure-containing (meth)acrylate such as t-butylcyclohexyl (meth)acrylate are particularly preferable.

Furthermore, as (Component B-1) the specific polymer, a novolac resin may be used, this being a resin formed by condensation of a phenol and an aldehyde under acidic conditions.

Preferred examples of the novolac resin include a novolac resin obtained from phenol and formaldehyde, a novolac resin obtained from m-cresol and formaldehyde, a novolac resin obtained from p-cresol and formaldehyde, a novolac resin obtained from o-cresol and formaldehyde, a novolac resin obtained from octylphenol and formaldehyde, a novolac resin obtained from mixed m-/p-cresol and formaldehyde, and a novolac resin obtained form a mixture of phenol/cresol (any of m-, p-, o- or m-/p-, m-/o-, o-/p-mixtures) and formaldehyde.

With regard to these novolac resins, those having a weight-average molecular weight of 800 to 200,000 and a number-average molecular weight of 400 to 60,000 are preferable.

An epoxy resin having a hydroxy group in a side chain may be used as (Component B-1) the specific polymer. A preferred example of the epoxy resin is an epoxy resin formed by polymerization, as a starting material monomer, of an adduct of bisphenol A and epichlorohydrin.

The epoxy resin preferably has a weight-average molecular weight of 800 to 200,000, and a number-average molecular weight of 400 to 60,000.

Among (Component B-1) specific polymers, polyvinyl butyral derivatives are particularly preferable from the viewpoint of rinsing properties and printing durability when the polymer is formed into the relief-forming layer.

In the polymers of any embodiment described above, the content of the hydroxy group contained in Component B in the present invention is preferably 0.1 to 15 mmol/g, and more preferably 0.5 to 7 mmol/g.

Component B as represented by (Component B-1) the specific polymer in the resin composition of the present invention may be used only in one type, or in two or more types in combination.

From the viewpoint of satisfying the shape retention, water resistance and engraving sensitivity of the coated film in a balanced manner, the content of Component B in the resin composition of the present invention is, in the total solids content, preferably 2 to 95 wt %, more preferably 5 to 80 wt %, and particularly preferably 10 to 60 wt %.

In regard to the resin composition of the present invention, the mechanism of action concerning the combined use of Component A and Component B will be explained. The mechanism of action is not clearly understood but is speculated to be as follows. Meanwhile, in the following descriptions, a case in which (Component B-1) a specific polymer is used as Component B will be described.

In the resin composition, a silane coupling group of Component A undergoes an alcohol exchange reaction with a hydroxy group (—OH) which is a reactive functional group in Component B-1 that is co-present in the system, and consequently, the molecules of Component B-1 are three-dimensionally crosslinked by Component A. As a result, (I) an effect is obtained in which when the resin composition is formed into a film, the elasticity of the film is increased, and plastic deformation is made difficult. The (I) increase in film elasticity brings about an effect that when the resin composition of the present invention is applied to a relief-forming layer, the ink transferability and print durability of the printing plate thus formed are increased. Furthermore, in the present invention, when Component A has a long carbon chain (may have heteroatoms in the chain) in the structure, a flexible film can be obtained. Furthermore, although a plasticizer is not added, sufficient flexibility can be obtained, and (II) bleeding of a plasticizer due to the addition of a plasticizer can be suppressed.

It is contemplated that when the molecules of Component B-1 are directly crosslinked with each other through Component A, a three-dimensional crosslinked structure is formed in the molecule, thereby the requirement of exhibiting rubber elasticity is satisfied, and apparently a rubber-like behavior is exhibited, so that as a result, (l) the film elasticity increasing effect is obtained. Therefore, it is speculated that when a film is formed from the resin composition of the present invention to produce a relief-forming layer, the film elasticity of the relief layer thus obtained is increased, and even in a state in which pressure is repeatedly applied in the process of printing for a long time period, plastic deformation is suppressed, so that excellent ink transferability is realized, and at the same time, print durability is also improved.

As such, the resin composition of the present invention containing Component A and (Component B-1) a specific polymer exhibits various excellent properties when, at the time of preparation of the composition and film formation, Component A reacts with a hydroxy group in (Component B-1) the specific polymer and forms a crosslinked structure. This effect is caused by a reaction between the functional groups that are respectively present in Component A and Component B and are interactive with each other. Here, an example between a hydrolyzable silyl group and/or a silanol group and a hydroxy group is taken, but the same mechanism of action also applies to other functional groups.

The confirmation of the occurrence in which the reaction between Component A and (Component B-1) the specific polymer proceeds in the resin composition of the present invention, and a crosslinked structure is formed, can be carried out by the following method.

The film obtained after crosslinking can be identified by using “solid ¹³C-NMR.”

The carbon atom that is directly bonded to the OH group in (Component B-1) the specific polymer undergoes a change in the electronic environment before and after the reaction with Component A, and therefore, the position of the peak changes with the change in the electronic environment. When the strength of a peak originating from a carbon atom that is directly bonded to an unreacted OH group, and the strength of a peak of a carbon atom that has reacted with Component A and formed an alkoxy group are compared before and after the crosslinking, it can be seen that an alcohol exchange reaction is actually in progress, and the approximate reaction ratio can be determined. Meanwhile, since the degree of change in the position of a peak varies depending on the structure of (Component B-1) the specific polymer used, this change is a relative indicator.

Furthermore, another example of the method may be a method of immersing the film before and after crosslinking in a solvent, and observing any change in the external appearance of the film by visual inspection. The progress of crosslinking can also be examined by using this method.

Specifically, when a film is formed from a resin composition, and the film is immersed in acetone at room temperature for 24 hours and is subjected to visual inspection of the external appearance, in the case where a crosslinked structure is not formed, or in the case where a crosslinked structure is formed only to a small extent, the film dissolves in acetone and is deformed to an extent that the external appearance is not retained, or the film dissolves and is brought to a state in which a solid cannot be identified by visual inspection. However, in the case where the film has a crosslinked structure, the film does not dissolve, and the external appearance of the film retains the state of that before the acetone immersion.

### <Solvent>

From the viewpoint of promoting the reaction between Component A and Component B, a solvent used when preparing the resin composition for laser engraving of the present invention is preferably mainly an aprotic organic solvent. The aprotic organic solvent may be used on its own or may be used in combination with a protic organic solvent. More specifically, they are used preferably at aprotic organic solvent/protic organic solvent=100/0 to 50/50 (ratio by weight), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

### (Component C) Silane Coupling Agent

The resin composition of the invention preferably comprises (Component C) a silane coupling agent. When the resin composition comprises Component C, a high crosslinking density can be obtained.

As (Component C) the silane coupling agent, (Component C-1) a polyfunctional silane coupling agent, and (Component C-2) a monofunctional silane coupling agent having an alkoxysilyl group are preferable, and Component C-1 is more preferable.

### (Component C-1) Polyfunctional Silane Coupling Agent

In the present invention, (Component C-1) a polyfunctional silane coupling agent is preferably used as (Component C) the silane coupling agent.

In the present invention, a functional group in which at least one alkoxy group or halogen group (halogen atom) is directly bonded to a Si atom is called a silane coupling group, and a compound having two or more silane coupling groups in a molecule is called a polyfunctional silane coupling agent. Silane coupling groups having two or more alkoxy groups or halogen atoms directly bonded to a Si atom are preferable, and those having three or more of these directly bonded are particularly preferable.

Component C has indispensably at least one functional group of an alkoxy group and a halogen atom directly bonded to a Si atom as the functional group, and, from the viewpoint of easy handling of the compound, one having an alkoxy group is preferable.

Here, from the viewpoint of rinsing properties and printing durability, the alkoxy group has preferably 1 to 30 carbon atoms, more preferably 1 to 15 carbon atoms, and particularly preferably 1 to 5 carbon atoms.

The halogen atom includes a F atom, a Cl atom, a Br atom and an I atom, and, from the viewpoint of the easiness of synthesis and stability, a Cl atom and a Br atom are preferable, and a Cl atom is more preferable.

From the viewpoint of maintaining the good balance of the crosslinking level and softness of the film, Component C-1 in the present invention contains the silane coupling group at least 2 in the molecule, preferably at least 2 but no greater than 10, more preferably at least 2 but no greater than 5, and particularly preferably at least 2 but no greater than 4.

The silane coupling groups are preferably linked each other by a linking group. As the linking group, di- or more valent organic groups that may have such substituent as a hetero atom or a hydrocarbon are cited, and, from the viewpoint of a high engraving sensitivity, an embodiment containing a hetero atom (N, S, O) is preferable, and a linking group containing a S atom is particularly preferable.

From such viewpoint, as Component C-1 in the present invention, a compound, which has two silane coupling groups having a methoxy group or an ethoxy group, particularly a methoxy group bonded to a Si atom as an alkoxy group in the molecule and these silane coupling groups are bonded via an alkylene group containing a hetero atom (particularly preferably a S atom), is preferable. More specifically, one having a linking group containing a sulfide group is preferable.

Examples of another preferable embodiment of the linking group linking silane coupling groups each other include a linking group having an oxyalkylene group. As the result that the linking group contains an oxyalkylene group, the rinsing properties of engraving residue after the laser engraving is improved. As the oxyalkylene group, an oxyethylene group is preferable, and a polyoxyethylene chain formed by linking plural oxyethylene groups is more preferable. The total number of oxyethylene groups in the polyoxyethylene chain is preferably 2 to 50, more preferably 3 to 30, and particularly preferably 4 to 15.

Examples of the polyfunctional silane coupling agent that can be used in the present invention are shown below. Examples of the polyfunctional silane coupling agent in the present invention include bis(triethoxysilylpropyl) disulfide, bis(triethoxysilylpropyl) tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, and bis(trimethoxysilylpropyl)urea. Other than the above, the compounds shown below can be cited as preferred examples, but the present invention should not be construed as being limited thereto.

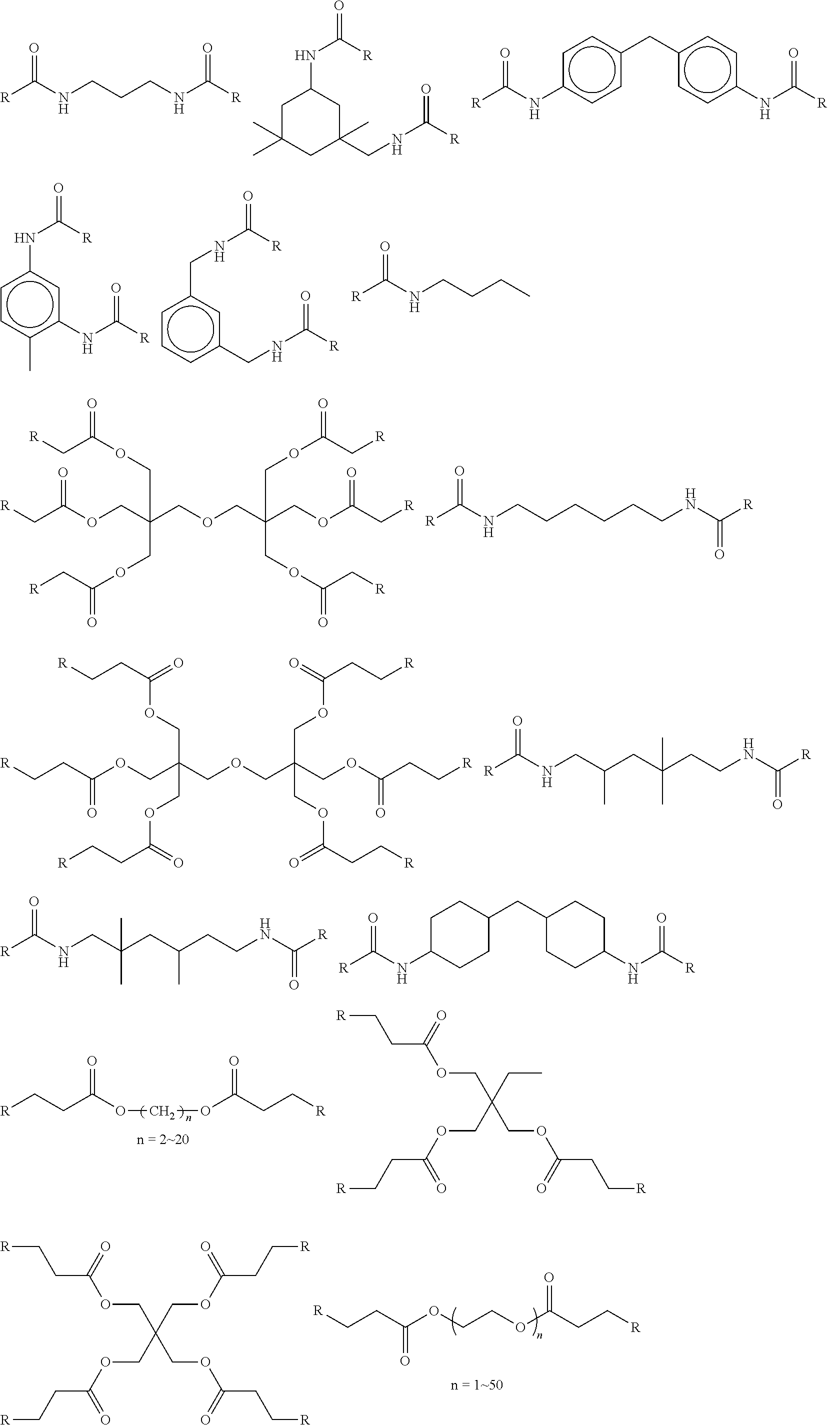

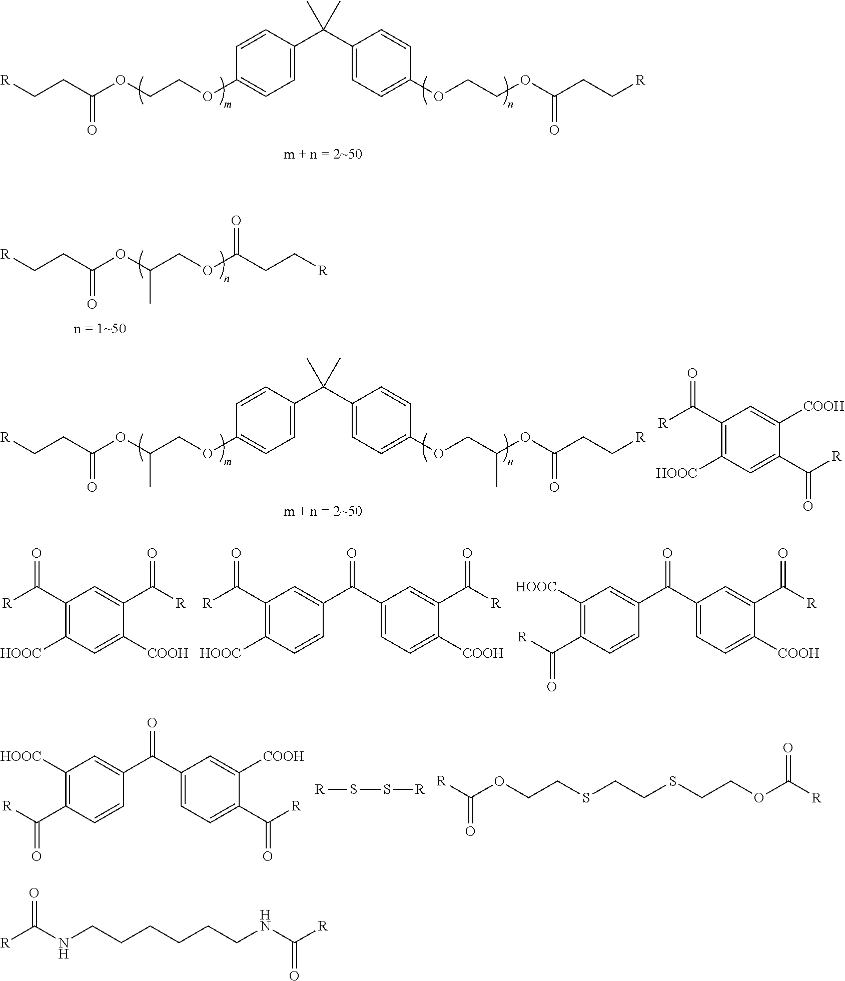

In each of the formulae above, R denotes a partial structure selected from the structures below. When a plurality of Rs and R¹s are present in the molecule, they may be identical to or different from each other, and are preferably identical to each other in terms of synthetic suitability. In the chemical structural formulae below, Et denotes an ethyl group and Me denotes a methyl group.

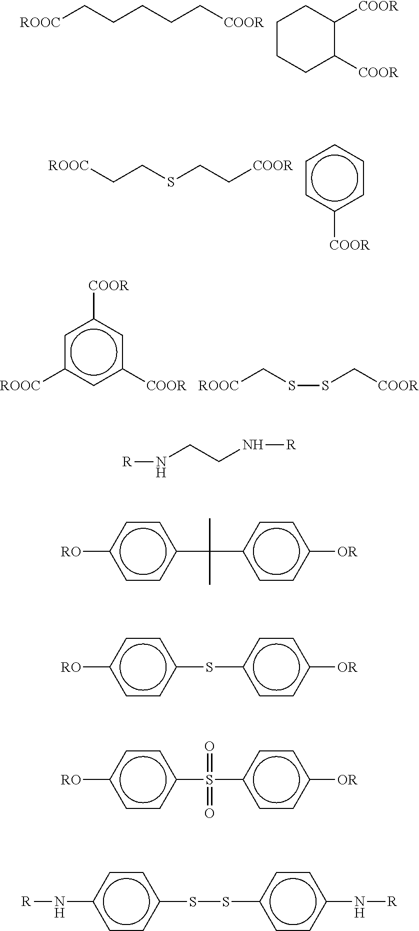

In each of the formulae above. R denotes a partial structure shown below. R¹ is the same as defined above. When a plurality of Rs and R¹s are present in the molecule, they may be identical to or different from each other, and in terms of synthetic suitability are preferably identical to each other.

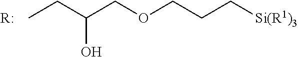

Component C-1 may be obtained by synthesis as appropriate, but use of a commercially available product is preferable in terms of cost. Since Component C-1 corresponds to for example commercially available silane products or silane coupling agents from Shin-Etsu Chemical Co., Ltd., Dow Corning Toray, Momentive Performance Materials Inc., Chisso Corporation, etc., the resin composition of the present invention may employ such a commercially available product by appropriate selection according to the intended application.

As Component C-1 in the present invention, other than the above-mentioned compounds, a partial hydrolysis-condensation product obtained using one type of silane compound having at least one silane coupling group or a partial cohydrolysis-condensation product obtained using two or more types may be used. Hereinafter, these compounds may be called ‘partial (co)hydrolysis-condensation products’.

Specific examples of such partial (co)hydrolysis condensates include a partial (co)hydrolysis condensate obtained by using, as a precursor, one or more selected from the group of silane compounds consisting of alkoxysilane or acetyloxysilane such as tetramethoxysilane, tetraethoxysilane, methyltrimethoxysilane, methyltriethoxysilane, methyltriisopropoxysilane, methyltriacetoxysilane, methyltris(methoxyethoxy)silane, methyltris(methoxypropoxy)silane, ethyltrimethoxysilane, propyltrimethoxysilane, butyltrimethoxysilane, hexyltrimethoxysilane, octyltrimethoxysilane, decyltrimethoxysilane, cyclohexyltrimethoxysilane, phenyltrimethoxysilane, phenyltriethoxysilane, tolyltrimethoxysilane, chloromethyltrimethoxysilane, γ-chloropropyltrimethoxysilane, 3,3,3-trifluoropropyltrimethoxysilane, cyanoethyltriethoxysilane, γ-glycidoxypropyltrimethoxysilane, γ-glycidoxypropyltriethoxysilane, β-(3,4-epoxycyclohexyl)ethyltrimethoxysilane, γ-aminopropyltrimethoxysilane, γ-aminopropyltriethoxysilane, N-β(aminoethyl)γ-aminopropyltrimethoxysilane, N-phenyl-γ-aminopropyltrimethoxysilane, γ-mercaptopropyltrimethoxysilane, dimethyldimethoxysilane, dimethyldiethoxysilane, diethyldimethoxysilane, methylethyldimethoxysilane, methylpropyldimethoxysilane, diphenyldimethoxysilane, diphenyldiethoxysilane, methylphenyldimethoxysilane, γ-chloropropylmethyldimethoxysilane, 3,3,3-trifluoropropylmethyldimethoxysilane, γ-glycidoxypropylmethyldiethoxysilane, γ-aminopropylmethyldiethoxysilane, N-β-(aminoethyl)-γ-aminopropylmethyldimethoxysilane and mercaptopropylmethyldiethoxysilane, and acyloxysilane such as ethoxalyloxysilane.

Among these silane compounds as partial (co)hydrolysis-condensation product precursors, from the viewpoint of versatility, cost, and film compatibility, a silane compound having a substituent selected from a methyl group and a phenyl group as a substituent on the silicon is preferable, and specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is desirable to use a dimer (2 moles of silane compound is reacted with 1 mole of water to eliminate 2 moles of alcohol, thus giving a disiloxane unit) to 100-mer of the above-mentioned silane compound, preferably a dimer to 50-mer, and yet more preferably a dimer to 30-mer, and it is also possible to use a partial cohydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

### (Component C-2) Monofunctional Silane Coupling Agent Having Alkoxysilyl Group

According to the present invention, (Component C-2) a monofunctional silane coupling agent having an alkoxysilyl group may also be used as (Component C) the silane coupling agent.

Here, the monofunctional silane coupling agent having an alkoxysilyl group is a compound which has only one silicon atom to which two or more alkoxy groups are directly bonded in the molecule, and is a compound which has only one silane coupling group described above. That is, the monofunctional silane coupling agent having an alkoxysilyl group is a compound having only one silicon atom to which an alkoxy group or a halogen atom is directly bonded, and to which two or more alkoxy groups are directly bonded.

Examples of C-2 include a dialkoxysilane, a trialkoxysilane, and a tetraalkoxysilane, and a trialkoxysilane and a tetraalkoxysilane are preferred.

Examples of Component C-2 include tetramethoxysilane, tetraethoxysilane, methyltrimethoxysilane, methyltriethoxysilane, methyltriisopropoxysilane, ethyltrimethoxysilane, propyltrimethoxysilane, butyltrimetyoxysilane, hexyltrimethoxysilane, octyltrimethoxysilane, decyltrimethoxysilane, cyclohexyltrimethoxysilane, phenyltrimethoxysilane, phenyltriethoxysilane, tolyltrimethoxysilane, chloromethyltrimethoxysilane, γ-chloropropyltrimethoxysilane, 3,3,3-trifluoropropyltrimethoxysilane, cyanoethyltriethoxysilane, β-(3,4-epoxycyclohexyl)ethyltrimethoxysilane, γ-glycidoxypropyltrimethoxysilane, γ-glycidoxypropyltriethoxysilane, γ-glycidoxypropylmethyldiethoxysilane, γ-glycidoxypropyltriethoxysilane, N-β-(aminoethyl)-γ-aminopropylmethyldimethoxysilane, N-γ-(aminoethyl)-γ-aminopropyltrimethoxysilane. N-β-(aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mereaptopropyltriethoxysilane, γ-chloropropyltrimethoxysilane, and γ-ureidopropyltriethoxysilane.

According to the present invention, only one kind of Component C may be used, or two or more kinds may be used in combination.

The content of Component C in the resin composition is preferably 3 wt % to 40 wt %, more preferably 5 wt % to 30 wt %, and yet more preferably 10 wt % to 20 wt %, relative to the weight of the total solids content. When the content of Component C is in the range described above, a relief-forming layer having excellent solvent resistance and film strength may be obtained.

Meanwhile, the content of Component C in the resin composition is such that when the content of Component A in the resin composition is defined as 100 parts by weight, the content is preferably 100 parts by weight or less, more preferably 100 to 30 parts by weight, and yet more preferably 90 to 50 parts by weight.

### (Component D) Photothermal Conversion Agent

The resin composition for laser engraving of the present invention preferably comprises (Component D) a photothermal conversion agent.

It is surmised that the photothermal conversion agent absorbs laser light and generates heat thus promoting thermal decomposition of a cured material of the resin composition for laser engraving of the present invention during laser engraving. Because of this, it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 nm to 1,300 nm is used as a light source for laser engraving, it is preferable to use a photothermal conversion agent that can absorb light having a wavelength of 700 nm to 1,300 nm, and it is more preferable to use a photothermal conversion agent having a maximum absorption wavelength of 700 nm to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 nm to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium dyes, pyrylium salts, and metal thiolate complexes.

Examples of the dyes that can preferably used in the present invention include cyanine-based dyes such as heptamethine cyanine dyes, oxonol-based dyes such as pentamethine oxonol dyes, and phthalocyanine-based dyes are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low dibutyl phthalate (DBP) absorption and also finely divided carbon black having a large specific surface area. Preferred examples of carbon black include Printex (registered trademark) U, Printex (registered trademark) A, and Spezialschwarz (registered trademark) 4 (Degussa).

From the viewpoint of improving engraving sensitivity by efficiently transmitting heat generated by photothermal conversion to the surrounding polymer, etc., the carbon black that can be used in the present invention is preferably a conductive carbon black having a specific surface area of at last 150 m²/g and a DBP number of at least 150 mL/100 g.

This specific surface area is preferably at least 250 m²/g, and particularly preferably at least 500 m²/g. The DBP number is preferably at least 200 mL/100 g, and particularly preferably at least 250 mL/100 g. The above-mentioned carbon black may be acidic or basic carbon black. The carbon black is preferably basic carbon black. It is of course possible to use a mixture of different carbon blacks.

Conductive carbon black having a specific surface area of about 1,500 m²/g and a DBP number of about 550 mL/100 g is commercially available under names such as for example Ketjenblack (registered trademark) EC300J, Ketjenblack (registered trademark) EC600J (Akzo), Printex (registered trademark) XE (Degussa), Black Pearls (registered trademark) 2000 (Cabot), and Ketjen Black (Lion Corporation).

When carbon black is used as the photothermal conversion agent, thermal crosslinking is more preferable in point of the curability of the film, instead of the photo crosslinking using UV light etc., and, by the combination with (c) the organic peroxide being (Component G) the polymerization initiator, which is the after-mentioned preferable component for use in combination, the engraving sensitivity becomes extremely high, more preferably.

As the most preferable embodiment of the present invention, as described above, an embodiment, in which Component B, furthermore one having a glass transition temperature of 20° C. or more as a Component B-2 for use in combination, an (c) organic peroxide being (Component G) the polymerization initiator and carbon black being (Component D) a photothermal conversion agent are used in combination, can be cited.

The content of the photothermal conversion agent in the resin composition for laser engraving of the present invention largely depends on the size of the molecular extinction coefficient characteristic to the molecule, and is preferably 0.01 to 20 wt % relative to the total weight of the solids content of the resin composition, more preferably 0.05 to 10 wt %, and yet more preferably 0.1 to 5 wt %.

### (Component E) Alcohol Exchange Reaction Catalyst

The resin composition of the present invention preferably further comprises (Component E) an alcohol exchange reaction catalyst in order to accelerate the reaction with Component A and Component B.

As (Component E) the alcohol exchange reaction catalyst, any reaction catalyst that is generally used in silane coupling reaction can be applied without limitation.

Hereinafter, (Component E-1) an acidic or a basic catalyst, and (Component E-2) a metal complex catalyst, which are representative alcohol exchange reaction catalysts, will be described in sequence.

### (Component E-1) Acidic or Basic Catalyst

As the catalyst, an acidic or a basic compound is used as it is or in the form of a solution in which it is dissolved in a solvent such as water or an organic solvent (hereinafter, called an acidic catalyst or a basic catalyst). The concentration when dissolved in a solvent is not particularly limited, and it may be selected appropriately according to the properties of the acidic or basic compound used, desired catalyst content, etc.

The type of the acidic or basic catalyst is not limited, and examples of the acidic catalyst include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, heteropoly acids, inorganic solid acids etc, and examples of the basic catalyst include an ammoniacal base such as aqueous ammonia, an amine such as ethyl amine and aniline, an alkali metal hydroxide, an alkali metal alkoxide, a quaternary ammonium salt compound, a quaternary phosphonium salt compound, etc.

As the basic catalyst that can be used in the present invention, an amine is explained as an example below.

Examples of the amine include compounds (a) to (e) shown below.

(a) a nitrogen hydride compound such as hydrazine;
(b) an aliphatic, aromatic or alicyclic, primary, secondary, or tertiary monoamine or polyamine (diamine, triamine, etc.);
(c) a monoamine or polyamine which is a cyclic amine, including a condensed ring, and in which at least one nitrogen atom is contained in the ring skeleton;
(d) an oxygen-containing amine such as an amino acid, an amide, an alcoholamine, an ether amine, an imide, or a lactam;
(e) a hetero element-containing amine containing a heteroatom such as O, S, or Se.

In the case of a secondary or tertiary amine, the substituents on the nitrogen atom (N) may be identical to or different from each other, and among these substituents one or more may be different and the others identical to each other.

Specific examples of the amine include hydrazine,

a primary amine such as monomethylamine, monoethylamine, monopropylamines, monobutylamines, monopentylamines, monohexylamines, monoheptylamines, vinylamine, allylamine, butenylamines, pentenylamines, hexenylamines, pentadienylamines, hexadienylamines, cyclopentylamine, cyclohexylamine, cyclooctylamine, p-menthylamine, cyclopentenylamines, cyclohexenylamines, cyclohexadienylamines, aniline, benzylamine, naphthylamine, naphthylmethylamine, toluidine, tolylenediamines, ethylenediamine, ethylenetriamine, monoethanolamine, aminothiophene, glycine, alanine, phenylalanine, or aminoacetone, a secondary amine such as dimethylamine, diethylamine, dipropylamines, dibutylamines, dipentylamines, dihexylamines, methylethylamine, methylpropylamines, methylbutylamines, methylpentylamines, methylhexylamines, ethylpropylamines, ethylbutylamines, ethylpentylamines, propylbutylamines, propylpentylamines, propylhexylamines, butylpentylamines, pentylhexylamines, divinylamine, diallylamine, dibutenylamines, dipentenylamines, dihexenylamines, methylvinylamine, methylallylamine, methylbutenylamines, methylpentenylamines, methylhexenylamines, ethylvinylamine, ethylallylamine, ethylbutenylamines, ethylpentenylamines, ethylhexenylamines, propylvinylamines, propylallylamines, propylbutenylamines, propylpentenylamines, propylhexenylamines, butylvinylamines, butylallylamines, butylbutenylamines, butylpentenylamines, butylhexenylamines, vinylallylamine, vinylbutenylamines, vinylpentenylamines, vinylhexenylamines, allylbutenylamines, allylpentenylamines, allylhexenylamines, butenylpentenylamines, butenylhexenylamines, dicyclopentylamine, dicyclohexylamine, methylcyclopentylamine, methylcyclohexylamine, methylcyclooctylamine, ethylcyclopentylamine, ethylcyclohexylamine, ethylcyclooctylamine, propylcyclopentylamines, propylcyclohexylamines, butylcyclopentylamines, butylcyclohexylamines, hexylcyclopentylamines, hexylcyclohexylamines, hexylcyclooctylamines, vinylcyclopentylamine, vinylcyclohexylamine, vinylcyclooctylamine, allylcyclopentylamine, allylcyclohexylamine, allylcyclooctylamine, butenylcyclopentylamines, butenylcyclohexylamines, butenylcyclooctylami nes, dicyclopentenylamines, dicyclohexenylamines, dicyclooctenylamines, methylcyclopentenylamines, methylcyclohexenylamines, methylcyclooctenylamines, ethylcyclopentenylamines, ethylcyclohexenylamines, ethylcyclooctenylamines, propylcyclopentenylamines, propylcyclohexenylamines, butylcyclopentenylamines, butylcyclohexenylamines, vinylcyclopentenylamines, vinylcyclohexenylamines, vinylcyclooctenylamines, allylcyclopentenylamines, allylcyclohexenylamines, butenylcyclopentenylamines, butenylcyclohexenylamines, dicyclopentadienylamines, dicyclohexadienylamines, dicyclooctadienylamines, methylcyclopentadienylamines, methylcyclohexadienylamines, ethylcyclopentadienylamines, ethylcyclohexadienylamines, propylcyclopentadienylamines, propylcyclohexadienylamines, dicyclooctatrienylamines, methylcyclooctatrienylamines, ethylcyclooctatrienylamines, vinylcyclopentadienylamines, vinylcyclohexadienylamines, allylcyclopentadienylamines, allylcyclohexadienylamines, diphenylamine, ditolylamines, dibenzylamine, dinaphthylamines, N-methylaniline, N-ethylaniline, N-propylanilines, N-butylanilines, N-methyltoluidine, N-ethyltoluidine, N-propyltoluidines, N-butyltoluidines, N-methylbenzylamine, N-ethylbenzylamine, N-propylbenzylamines, N-butylbenzylamines, N-methylnaphthylamines, N-ethylnaphthylarnines, N-propylnaphthylamines, N-vinylaniline, N-allylaniline, N-vinylbenzylamine, N-allylbenzylamine, N-vinyltoluidine, N-allyltoluidine, phenylcyclopentylamine, phenylcyclohexylamine, phenylcyclooctylamine, phenylcyclopentenylamines, phenylcyclohexenylamines, phenylcyclopentadienylamines, N-methylethylenediamine, N,N′-dimethylethylenediamine, N-ethylethylenediamine, diethylethylenediamine, N,N′-dimethyltolylenediamines, N,N′-diethyltolylenediamines, N-methylethylenetriamine, N,N′-dimethylethylenetriamine, pyrrole, pyrrolidine, imidazole, piperidine, piperazine, methylpyrroles, methylpyrrolidines, methylimidazoles, methylpiperidines, methylpiperazines, ethylpyrroles, ethylpyrrolidines, ethylimidazoles, ethylpiperidines, ethylpiperazines, phthalimide, maleimide, caprolactam, pyrrolidone, morpholine, N-methylglycine, N-ethylglycine, N-methylalanine, N-ethylalanine, N-methylaminothiophene, N-ethylaminothiophene, 2,5-piperazinedione, N-methylethanolamine, N-ethylethanolamine, or purine.

Examples of the tertiary amines include trimethylamine, triethylamine, tripropylamines, tributylamines, tripentylamines, trihexylamines, dimethylethylamine, dimethylpropylamines, dimethylbutylamines, dimethylpentylamines, dimethylhexylamines, diethylpropylamines, diethylbutylamines, diethylpentylamines, diethylhexylamines, dipropylbutylamines, dipropylpentylamines, dipropylhexylamines, dibutylpentylamines, dibutylhexylamines, dipentylhexylamines, methyldiethylamine, methyldipropylamines, methyldibutylamines, methyldipentylamines, methyldihexylamines, ethyldipropylamines, ethyldibutylamines, ethyldipentylamines, ethyldihexylamines, propyldibutylamines, propyldipentylamines, propyldihexylamines, butyldipentylamines, butyldihexylamines, pentyldihexylamines, methylethylpropylamines, methylethylbutylamines, methylethylhexylamines, methylpropylbutylamines, methylpropylhexylamines, ethylpropylbutylamine, ethylbutylpentylamines, ethylbutylhexylamines, propylbutylpentylamines, propylbutylhexylamines, butylpentylhexylamines, trivinylamine, triallylamine, tributenylamines, tripentenylamines, trihexenylamines, dimethylvinylamine, dimethylallylamine, dimethylbutenylamines, dimethylpentenylamines, diethylyinylamine, diethylallylamine, diethylbutenylamines, diethylpentenylamines, diethylhexenylamines, dipropylvinylamines, dipropylallylamines, dipropylbutenylamines, methyldivinylamine, methyldiallylamine, methyldibutenylamines, ethyldivinylamine, ethyldiallylamine, tricyclopentylamine, tricyclohexylamine, tricyclooctylamine, tricyclopentenylamines, tricyclohexenylamines, tricyclopentadienylamines, tricyclohexadienylamines, dimethylcyclopentylamine, diethylcyclopentylamine, dipropylcyclopentylamines, dibutylcyclopentylamines, dimethylcyclohexylamine, diethylcyclohexylamine, dipropylcyclohexylamines, dimethylcyclopentenylamines, diethylcyclopentenylamines, dipropylcyclopentenylamines, dimethylcyclohexenylamines, diethylcyclohexenylamines, dipropylcyclohexenylamines, methyldicyclopentylamine, ethyldicyclopentylamine, propylcyclopentylamines, methyldicyclohexylamine, ethyldicyclohexylamine, propyldicyclohexylamines, methyldicyclopentenylamines, ethyldicyclopentenylamines, propyldicyclopentenylamines, N,N-dimethylaniline, N,N-dimethylbenzylamine, N,N-dimethyltoluidines, N,N-dimethylnaphthylamines, N,N-diethylaniline, N,N-diethylbenzylamine, N,N-diethyltoluidines, N,N-diethylnaphthylamines, N,N-dipropylanilines, N,N-dipropylbenzylamines, N,N-dipropyltoluidines, N,N-dipropylnaphthylamines, N,N-divinylaniline, N,N-diallylaniline, N,N-divinyltoluidines, N,N-diallytaniline, diphenylmethylamine, diphenylethylamine, diphenylpropylamines, dibenzylmethylamine, dibenzylethylamine, dibenzylcyclohexylamine, dibenzylvinylamine, dibenzylallylamine, ditolylmethylamines, ditolylethylamines, ditolylcyclohexylamines, ditolylvinylamines, triphenylamine, tribenzylamine, tri(tolyl)amines, trinaphthylamines, N,N,N′,N′-tetramethylethylenediamine, N,N,N′,N′-tetraethylethylenediamine, N,N,N′,N′-tetramethyltolylenediamines, N,N,N′,N′-tetraethyltolylenediamines, N-methylpyrrole, N-methylpyrrolidine, N-methylimidazole, N,N′-dimethylpiperazine, N-methylpiperidine, N-ethylpyrrole, N-ethylpyrrolidine, N-ethylimidazole, N,N′-diethylpiperazine, N-ethylpiperidine, pyridine, pyridazine, pyrazine, quinoline, quinazoline, quinuclidine, N-methylpyrrolidone, N-methylmorpholine, N-ethylpyrrolidone, N-ethylmorpholine, N,N-dimethylglycine, N,N-diethylglycine, N,N-dimethylalanine, N,N-diethylalanine, N,N-dimethylethanolamine, N,N-dimethylaminothiophene, 1,1,3,3-tetramethylguanidine, 1,8-diazabicyclo[5.4.0]undeca-7-ene, 1,5-diazabicyclo[4.3.0]nona-5-ene, 1,4-diazabicyclo[2.2.2]octane and hexamethylenetetramine etc.

Therefore, the above-mentioned amine that can be used as the basic catalyst is preferably a compound in which an aliphatic or alicyclic saturated or unsaturated hydrocarbon group, an aromatic hydrocarbon group, an oxygen-containing and/or sulfur-containing and/or selenium-containing hydrocarbon group, etc. is bonded to one or more nitrogen atoms. From the viewpoint of film strength after thermal crosslinking, the pKaH (acid dissociation constant of conjugated acid) range that is preferable as the amine is preferably 7 or greater, and more preferably 10 or greater.

Among the acidic catalysts and basic catalysts, from the viewpoint of an alcohol exchange reaction in the film progressing promptly, methanesulfonic acid, p-toluenesulfonic acid, pyridinium p-toluenesulfonate, dodecylbenzenesulfonic acid, phosphoric acid, phosphonic acid, acetic acid, 1,8-diazabicyclo[5.4.0]undec-7-ene, 1,5-diazabicyclo[4.3.0]non-5-ene, and 1,1,3,3-tetramethylguanidine are preferable, and methanesulfonic acid, p-toluenesulfonic acid, phosphoric acid, 1,8-diazabicyclo[5.4.0]undec-7-ene, and 1,5-diazabicyclo[4.3.0]non-5-ene are particularly preferable.

### (Component E-2) Metal Complex Catalyst

(Component E-2) The metal complex catalyst that can be used as an alcohol exchange reaction catalyst in the present invention is preferably constituted from a metal element selected from Groups 2A, 3B, 4A, and 5A of the periodic table and an oxo or hydroxy oxygen compound selected from β-diketones, ketoesters, hydroxycarboxylic acids and esters thereof, amino alcohols, and enolic active hydrogen compounds.

Furthermore, among the constituent metal elements, a Group 2A element such as Mg, Ca, Sr, or Ba, a Group 3B element such as Al or Ga, a Group 4A element such as Ti or Zr, and a Group 5A element such as V, Nb, or Ta are preferable, and they form a complex having an excellent catalytic effect. Among them, a complex obtained from Zr, Al, or Ti, such as ethyl orthotitanate, is excellent and preferable.

In the present invention, examples of the oxo or hydroxy oxygen-containing compound constituting a ligand of the above-mentioned metal complex include β-diketones such as acetylacetone (2,4-pentanedione) and 2,4-heptanedione, ketoesters such as methyl acetoacetate, ethyl acetoacetate, and butyl acetoacetate, hydroxycarboxylic acids and esters thereof such as lactic acid, methyl lactate, salicylic acid, ethyl salicylate, phenyl salicylate, malic acid, tartaric acid, and methyl tartarate, ketoalcohols such as 4-hydroxy-4-methyl-2-pentanone, 4-hydroxy-2-pentanone, 4-hydroxy-4-methyl-2-pentanone, and 4-hydroxy-2-heptanone, amino alcohols such as monoethanolamine, N,N-dimethylethanolamine, N-methylmonoethanolamine, diethanolamine, and triethanolamine, enolic active compounds such as methylolmelamine, methylolurea, methylolacrylamide, and diethyl malonate ester, and compounds having a substituent on the methyl group, methylene group, or carbonyl carbon of acetylacetone (2,4-pentanedione).

A preferred ligand is an acetylacetone derivative, and the acetylacetone derivative in the present invention means a compound having a substituent on the methyl group, methylene group, or carbonyl carbon of acetylacetone. The substituent with which the methyl group of acetylacetone is substituted is a straight-chain or branched alkyl group, acyl group, hydroxyalkyl group, carboxyalkyl group, alkoxy group, or alkoxyalkyl group that all have 1 to 3 carbon atoms, the substituent with which the methylene carbon of acetylacetone is substituted is a carboxy group or a straight-chain or branched carboxyalkyl group or hydroxyalkyl group that all have 1 to 3 carbon atoms, and the substituent with which the carbonyl carbon of acetylacetone is substituted is an alkyl group having 1 to 3 carbon atoms, and in this case the carbonyl oxygen turns into a hydroxy group by addition of a hydrogen atom.

Specific preferred examples of the acetylacetone derivative include acetylacetone, ethylcarbonylacetone, n-propylcarbonylacetone, i-propylcarbonylacetone, diacetylacetone, 1-acetyl-1-propionylacetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol, and among them acetylacetone and diacetylacetone are particularly preferable. The complex of the acetylacetone derivative and the metal element is a mononuclear complex in which 1 to 4 molecules of acetylacetone derivative coordinate to one metal element, and when the number of coordinatable sites of the metal element is larger than the total number of coordinatable bond sites of the acetylacetone derivative, a ligand that is usually used in a normal complex, such as a water molecule, a halide ion, a nitro group, or an ammonio group may coordinate thereto.

Preferred examples of the metal complex include a tris(acetylacetonato)aluminum complex salt, a di(acetylacetonato)aluminum-aqua complex salt, a mono(acetylacetonato)aluminum-chloro complex salt, a di(diacetylacetonato)aluminum complex salt, ethyl acetoacetate aluminum diisopropylate, aluminum tris(ethyl acetoacetate), cyclic aluminum oxide isopropylate, a tris(acetylacetonato)barium complex salt, a di(acetylacetonato)titanium complex salt, a tris(acetylacetonato)titanium complex salt, a di-i-propoxy-bis(acetylacetonato)titanium complex salt, zirconium tris(ethyl acetoacetate), and a zirconium tris(benzoic acid) complex salt. They are excellent in terms of stability in an aqueous coating solution and an effect in promoting gelling in a sol-gel reaction when thermally drying, and among them ethyl acetoacetate aluminum diisopropylate, aluminum tris(ethyl acetoacetate), a di(acetylacetonato)titanium complex salt, and zirconium tris(ethyl acetoacetate) are particularly preferable.

In the resin composition of the present invention, only one kind of (Component E) the alcohol exchange reaction catalyst may be used, or two or more kinds may be used in combination.

The content of (Component E) the alcohol exchange reaction catalyst in the resin composition is preferably 0.01 wt % to 20 wt %, and more preferably 0.1 wt % to 10 wt %, relative to the weight of Component B.

The resin composition of the present invention can use various compounds in combination in accordance with the purpose, in addition to Component A and Component B which are essential components, as well as Component C and Component D which are preferable components to be used in combination, to the extent that the effect of the present invention is not impaired.

### (Component B-2) Binder Polymer for Use in Combination

The resin composition for laser engraving of the present invention may comprise in addition to the Component B a binder polymer for use in combination, which is known and not included as Component B, such as a binder polymer having no functional group that is capable of reacting with a hydrolysable silyl group and/or a silanol group and thereby forming a crosslinking structure. Such binder polymers are referred as (Component B-2) a binder polymer for use in combination.

(Component B-2) The binder polymer is a primary component of the resin composition for laser engraving in addition to Component B above, and a general polymer compound not classified as Component B may be selected appropriately and used singly or in combination of two or more types. In particular, when the resin composition for laser engraving is to be used as a relief printing plate precursor for laser engraving, preferably the selection is performed while considering various performances such as laser engraving properties, ink-adhering properties, and dispersion properties of engraving residue.

(Component B-2) The binder polymer for use in combination may be selected and used from polystyrene resin, polyester resin, polyamide resin, polyurea resin, polyamideimide resin, polyurethane resine, polysulfone resin, polyethersulfone resin, polyimide resin, polycarbonate resin, hydrophilic polymer comprising a hydroxyethylene unit, acrylic resin, acetal resin, rubber, thermoplastic elastomer, etc.

For example, from the viewpoint of laser engraving sensitivity, a polymer comprising a partial structure that is thermally decomposed by exposure or heating is preferable. As such polymer, those described in JP-A-2008-163081, paragraph 0038 are preferably cited. Moreover, when a purpose is to form a film that has softness and flexibility, a soft resin or a thermoplastic elastomer is selected. There is detailed description in JP-A-2008-163081, paragraphs 0039 to 0040. Furthermore, in the case where the resin composition for laser engraving is applied to the relief-forming layer in the relief printing plate precursor for laser engraving, from the viewpoint of easiness of preparing a composition for the relief-forming layer and improvement of resistance properties for an oil-based ink in the relief printing plate to be obtained, the use of a hydrophilic or alcoholphilic polymer is preferable. As the hydrophilic polymer, those described in detail in JP-A-2008-163081, paragraph 0041 can be used.

Furthermore, a polyester containing a hydroxycarboxylic acid unit such as polylactic acid may preferably be used. Specifically, such a polyester is preferably selected from the group consisting of a polyhydroxyalkanoate (PHA), a lactic acid-based polymer, polyglycolic acid (PGA), polycaprolactone (PCL), poly(butylenesuccinic acid), and derivatives and mixtures thereof.

In addition, when it is used for the purpose of curing by heat or light exposure and improving strength, a polymer having a carbon-carbon unsaturated bond in the molecule is preferably used.

As a polymer having a carbon-carbon unsaturated bond in the main chain, SB (polystyrene-polybutadiene), SBS (polystyrene-polybutadiene-polystyrene), SIS (polystyrene-polyisoprene-polystyrene), SEBS (polystyrene-polyethylene/polybutylene-polystyrene), etc. can be cited.

A polymer having a carbon-carbon unsaturated bond in a side chain may be obtained by introducing, into a side chain of the skeleton of the binder polymer applicable in the present invention, a carbon-carbon unsaturated bond such as an allyl group, an acryloyl group, a methacryloyl group, a styryl group, or a vinyl ether group. As a method for introducing a carbon-carbon unsaturated bond into a binder polymer side chain, a known method such as a method in which a polymer is copolymerized with a structural unit having a polymerizable group precursor formed by bonding a protecting group to a polymerizable group, and the protecting group is removed to give a polymerizable group or a method in which a polymer compound having a plurality of reactive groups such as hydroxy groups, amino groups, epoxy groups, or carboxy groups is prepared and a polymer reaction is carried out with a compound having a carbon-carbon unsaturated bond and a group that reacts with these reactive groups may be employed. In accordance with these methods, the amount of unsaturated bond and polymerizable group introduced into the polymer compound can be controlled.

As described above, the binder polymer may be used singly or in combination of two or more taking into consideration physical properties in accordance with the use application of relief printing plate and selecting them for the purpose.

The weight-average molecular weight (polystyrene basis by GPC measurement) of the binder polymer in the present invention is preferably 5,000 to 500,000. When the weight-average molecular weight is at least 5,000, the shape retention as a single resin is excellent, and when it is no greater than 500,000, it is easily dissolved in a solvent such as water and it is convenient for preparation of the relief-forming layer. The weight-average molecular weight of the binder polymer is more preferably 10,000 to 400,000, and particularly preferably 15,000 to 300,000.

The total content of the binder polymer (sum total of contents of Component B and Component B-2) is preferably 5 to 95 wt % relative to a solids content basis total weight of the resin composition for laser engraving, more preferably 15 to 80 wt %, and yet more preferably 20 to 65 wt %.

For example, when the resin composition for laser engraving of the present invention is applied to the relief-forming layer of the relief printing plate precursor, setting the content of the binder polymer to at least 5 wt % gives printing durability that is sufficient for the relief printing plate so obtained to be used as a printing plate, and setting it to no greater than 80 wt % gives flexibility that is sufficient for the relief printing plate so obtained to be used as a flexographic printing plate, without making other components insufficient.

Hereinafter, a preferable embodiment in the case of applying the resin composition of the present invention to a relief-forming layer will be described.

The relief-forming layer in the present invention is preferably formed from a resin composition (the resin composition of the present invention) comprising Component A and Component B, which are described above as essential components in the resin composition of the present invention, Component D or Component B-2, which is used as desired, and an optional component such as a polymerizable compound, a photothermal conversion agent, a polymerization initiator, or a plasticizer. These components are described in detail below.

### (Component F) Polymerizable Compound

In the present invention, from the viewpoint of forming a crosslinked structure in the relief-forming layer, the coating solution for the relief-forming layer (the resin composition of the present invention) preferably comprises (Component F) a polymerizable compound.

Polymerizable compounds that can be used here can be selected from the compounds having at least one ethylenically unsaturated double bond, and preferably selected from the compounds having 2 or more ethylenically unsaturated double bonds, and yet more preferably selected from the compounds having 2 to 6 ethylenically unsaturated double bonds.

Hereinafter, a monofunctional monomer having one ethylenically unsaturated double bond in the molecule and a polyfunctional monomer having two or more of the above group in the molecule are explained.

Since the relief-forming layer in the present invention preferably has a crosslinked structure in the film, a polyfunctional monomer is preferably used. The molecular weight of such a polyfunctional monomer is preferably 200 to 2,000.

Examples of the monofunctional monomer include an ester of an unsaturated carboxylic acid (e.g. acrylic acid, methacrylic acid, itaconic acid, crotonic acid, isocrotonic acid, maleic acid, etc.) and a monohydric alcohol compound, and an amide of an unsaturated carboxylic acid and a monoamine compound. Examples of the polyfunctional monomer include an ester of an unsaturated carboxylic acid (e.g. acrylic acid, methacrylic acid, itaconic acid, crotonic acid, isocrotonic acid, maleic acid, etc.) and a polyhydric alcohol compound, and an amide of an unsaturated carboxylic acid and a polyamine compound.

Furthermore, an addition reaction product of an unsaturated carboxylic acid ester or amide having a nucleophilic substituent such as a hydroxy group, an amino group, or a mercapto group with a monofunctional or polyfunctional isocyanate or epoxy, a dehydration-condensation reaction product with a monofunctional or polyfunctional carboxylic acid, etc. are also suitably used.

Furthermore, as the polymerizable compound having an ethylenically unsaturated group, addition products of unsaturated carboxylic acid esters or amides having an electrophilic substituent such as an isocyanate group or an epoxy group with a monofunctional or polyfunctional alcohol, amine or thiol, and substitution products of unsaturated carboxylic acid esters or amides having a leaving substituent such as a halogeno group or a tosyloxy group with a monofunctional or polyfunctional alcohol, amine or thiol are also preferable.

In addition, as other examples, the use of compounds obtained by substituting the unsaturated carboxylic acid by an unsaturated sulfonic acid, styrene, a vinyl ether or the like is also possible.

The polymerizable compound is not particularly limited, and, in addition to compounds exemplified above, various known compounds may be used. For example, compounds described in JP-A-2009-204962, paragraphs 0098 to 0124 may be used.

From the viewpoint of improving engraving sensitivity, it is preferable in the present invention to use as the polymerizable compound a compound having a sulfur atom in the molecule.

As such a polymerizable compound having a sulfur atom in the molecule, it is preferable from the viewpoint of improving engraving sensitivity in particular to use a polymerizable compound having two or more ethylenically unsaturated bonds and having a carbon-sulfur bond at a site where two ethylenically unsaturated bonds among them are linked (hereinafter, referred as a ‘sulfur-containing polyfunctional monomer’ as appropriate).

Examples of carbon-sulfur bond-containing functional groups of the sulfur-containing polyfunctional monomer in the present invention include sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, and thiourea-containing functional groups.

Furthermore, a linking group containing a carbon-sulfur bond linking two ethylenically unsaturated bonds of the sulfur-containing polyfunctional monomer is preferably at least one unit selected from —C—S—, —C—S—S—, —NHC(═S)O—, —NHC(═O)S—, —NHC(═S)S—, and —C—SO₂—.

Moreover, the number of sulfur atoms contained in the sulfur-containing polyfunctional monomer molecule is not particularly limited as long as it is one or more, and may be selected as appropriate according to the intended application, but from the viewpoint of a balance between engraving sensitivity and solubility in a coating solvent it is preferably 1 to 10, more preferably 1 to 5, and yet more preferably 1 or 2.

On the other hand, the number of ethylenically unsaturated bond sites contained in the molecule is not particularly limited as long as it is two or more and may be selected as appropriate according to the intended application, but from the viewpoint of flexibility of a crosslinked film it is preferably 2 to 10, more preferably 2 to 6, and yet more preferably 2 to 4.

From the viewpoint of flexibility of a film that is formed, the molecular weight of the sulfur-containing polyfunctional monomer in the present invention is preferably 120 to 3,000, and more preferably 120 to 1,500.

Furthermore, the sulfur-containing polyfunctional monomer in the present invention may be used on its own or as a mixture with a polyfunctional polymerizable compound or monofunctional polymerizable compound having no sulfur atom in the molecule.

Moreover, examples of the polymerizable compound having a sulfur atom in the molecule include those described in paragraphs 0032 to 0037 of JP-A-2009-255510, and the compounds described therein may be used in the present invention.

From the viewpoint of engraving sensitivity, a mode in which a sulfur-containing polyfunctional monomer is used on its own or a mixture of a sulfur-containing polyfunctional monomer and a monofunctional ethylenically unsaturated monomer is used is preferable, and a mode in which a mixture of a sulfur-containing polyfunctional monomer and a monofunctional ethylenically unsaturated monomer is used is more preferable.

In the relief-forming layer according to the present invention, when polymerizable compounds including sulfur-containing polyfunctional monomers are used, film properties, for example, brittleness and flexibility can be adjusted.

Furthermore, the total content of (Component F) the polymerizable compounds including sulfur-containing polyfunctional monomers in the relief-forming layer is, from the viewpoint of flexibility and brittleness of the crosslinked film, preferably in the range of 10 wt % to 60 wt %, and more preferably in the range of 15 wt % to 45 wt %, relative to the weight of non-volatile components.

Meanwhile, when a sulfur-containing polyfunctional monomer is used in combination with another polymerizable compound, the amount of the sulfur-containing polyfunctional monomer among all the polymerizable compounds is preferably 5 wt % or greater, and more preferably 10 wt % or greater.

### (Component G) Polymerization Initiator

The resin composition for laser engraving of the present invention preferably comprises (Component G) polymerization initiator when using the resin composition for producing a relief-forming layer.

With regard to the polymerization initiator, one known to a person skilled in the art may be used without any limitations. Radical polymerization initiators, which are preferred polymerization initiators, are explained in detail below, but the present invention should not be construed as being limited to these descriptions.

In the present invention, preferred examples of the radical polymerization initiator include (a) an aromatic ketone, (b) an onium salt compound, (c) an organic peroxide, (d) a thio compound, (e) a hexaarylbiimidazole compound, (f) a ketoxime ester compound, (g) a borate compound, (h) an azinium compound, (i) a metallocene compound, (j) an active ester compound, (k) a compound having a carbon halogen bond, and (l) an azo-based compound. Specific examples of the (a) to (l) above are shown below, but the present invention is not limited to these.

In the present invention, (c) an organic peroxide and (l) an azo-based compound is preferable, and (c) an organic peroxide is particularly preferable from the viewpoint of improving the engraving sensitivity and relief edge shape when it is applied to the relief-forming layer in the relief printing plate precursor.

As before-mentioned (a) aromatic ketones, (b) onium salt compounds, (d) a thio compound, (e) hexaarylbiimidazole compounds, (f) a ketoxime ester compound, (g) a borate compound, (h) an azinium compound, (i) metallocene compounds, (j) an active ester compound, (k) compounds having a carbon-halogen bond, the compounds described in JP-A-2008-63554, paragraphs 0074 to 0118 can preferably be used.

Examples of (c) organic peroxides and (l) azo-based compounds include compounds as shown below.

### (c) Organic Peroxides

Preferable (c) organic peroxides as the radical polymerization initiator which can be used in the present invention is preferably ether peroxide such as 3,3′,4,4′-tetra(tertiarybutylperoxycarbonyl)benzophenone, 3,3′,4,4′-tetra(tertiaryamylperoxycarbonyl)benzophenone, 3,3′,4,4′-tetra(tertiaryhexylperoxycarbonyl)benzophenone, 3,3′,4,4′-tetra(tertiaryoctylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-tertiarybutyldiperoxy isophthalate etc.

### (l) Azo-Based Compound

Preferable (l) azo-based compounds used as the radical polymerization initiator in the present invention include 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), 2,2′-dimethyl azobisisobutyrate, 2,2′-azobis(2-methylpropionamidoxime), 2,2′-azobis[2-(2-imidazoline-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], and 2,2′-azobis(2,4,4-trimethylpentane), etc.

In the present invention, the above-mentioned (c) organic peroxide is preferable as the polymerization initiator in the present invention from the viewpoint of the crosslinking properties of the film (relief-forming layer), and particularly preferable from the viewpoint of improving the engraving sensitivity, which is an unpredictable effect.

From the viewpoint of the engraving sensitivity, an embodiment obtained by combining (c) an organic peroxide and a polymer having a glass transition temperature of ordinary temperature or more, as Component B or Component B-2 is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the radiated laser energy to thus raise the engraving sensitivity.

It is presumed that, in the case where the glass transition temperature of Component B is ordinary temperature or more, the heat generated caused by the decomposition of the organic peroxide is transmitted effectively to Component B or Component B-1 and utilized effectively to the thermal decomposition of Component B or Component B-1 itself to thus make the sensitivity more higher.

It has been described in detail in the explanation of a light-heat converting agent, the effect thereof is remarkable when carbon black is used as the photothermal conversion agent. It is considered that the heat generated from the carbon black is also transmitted to (c) an organic peroxide and, as the result, heat is generated not only from the carbon black but also from the organic peroxide, and that the generation of heat energy to be used for the decomposition of Component B etc. occurs synergistically.

With regard to (Component G) a polymerization initiator in the present invention, one type may be used on its own or two or more types may be used in combination.

The content of (Component G) a polymerization initiator in the resin composition is preferably 0.01 to 10 wt % relative to the total solids content by weight of the resin composition, and more preferably 0.1 to 3 wt %. When the content of the polymerization initiator is at least 0.01 wt %, an effect from the addition thereof is obtained, and crosslinking of a crosslinkable relief-forming layer proceeds promptly. Furthermore, when the content is no greater than 10 wt %, other components do not become insufficient, and printing durability that is satisfactory as a relief printing plate is obtained.

### <Other Additives>

The resin composition for laser engraving of the present invention may comprise a plasticizer. The plasticizer has the function of softening a film formed from the resin composition for laser engraving and is required to be compatible with a binder polymer.

Examples of the plasticizer that are preferably used include dioctyl phthalate, didodecyl phthalate, a polyethylene glycol, and polypropylene glycol (monool type or diol type).

Meanwhile, in the present invention, since Component A also has a function of a plasticizer, it is preferable not to incorporate a plasticizer. When a plasticizer is not added, bleeding due to the addition of a plasticizer and elution into the solvent are suppressed. In conventional resin compositions, it has been necessary to additionally incorporate a plasticizer for the purpose of softening the film. However, since a plasticizer causes bleeding (effusion) from the (crosslinked) relief-forming layer or the relief layer, thereby causing stickiness of the surface, or since a plasticizer is eluted by the solvent, solvent resistance is deteriorated, and deformation or cracking of the film may occur in some cases. In the present invention, when Component A is used, the use of a plasticizer is suppressed to a low level, or it is possible not to use a plasticizer, and the problem described above can be suppressed.

According to the present invention, it is preferable that the resin composition do not comprise a plasticizer, or comprise a plasticizer in an amount of 5 wt % or less relative to the total solids content of the resin composition; and it is more preferable that the resin composition do not comprise a plasticizer, or comprise a plasticizer in an amount of 3 wt % or less relative to the total solids content of the resin composition. It is yet more preferable that the resin composition do not comprise a plasticizer, or comprise a plasticizer in an amount of 1 wt % or less relative to the total solids content of the resin composition; and it is particularly preferable that the resin composition do not comprise a plasticizer.

In the resin composition for laser engraving of the present invention, as an additive for improving engraving sensitivity, it is preferable that a nitrocellulose or highly heat-conductive material be added. The nitrocellulose is a self-reactive compound, during laser engraving, the nitrocellulose itself generates heat to assist the thermal decomposition of the binder polymer such as a coexisting hydrophilic polymer. As a result, it is assumed that engraving sensitivity is improved. The highly heat-conductive material is added for the purpose of assisting heat conduction, and examples of the heat-conductive material include an inorganic compound such as metal particles and an organic compound such as a conductive polymer. As the metal particles, small gold particles, small silver particles, and small copper particles having a particle size in the order of micrometers to several nanometers are preferable. As the conductive polymer, a conjugated polymer is particularly preferable, and specific examples thereof include polyaniline and polythiophene.

In addition, by using a co-sensitizer, the sensitivity when the resin composition for laser engraving is cured by light is further improved.

Further, during the production and preservation of composition, it is preferable that a small amount of thermal polymerization inhibitor be added for preventing unnecessary thermal polymerization of the polymerizable compound.

For the purpose of coloring the resin composition for laser engraving, colorant such as dye or pigment may be added. Accordingly, properties such as visibility of the image section and aptitude for an image density measuring machine can be improved.

Furthermore, in order to improve the properties of a cured film of the resin composition for laser engraving, known additives such as a filler may also be added.

### 2. Relief Printing Plate Precursor for Laser Engraving

A first embodiment of the relief printing plate precursor for laser engraving of the present invention comprises a relief-forming layer formed from the resin composition for laser engraving of the present invention.

A second embodiment of the relief printing plate precursor for laser engraving of the present invention comprises a crosslinked relief-forming layer formed by crosslinking a relief-forming layer formed from the resin composition for laser engraving of the present invention.

In the present invention, the ‘relief printing plate precursor for laser engraving’ means both or one of a plate having a crosslinkable relief-forming layer formed from the resin composition for laser engraving in a state before being crosslinked and a plate in a state in which it is cured by light or heat.

In the present invention, the ‘relief-forming layer’ means a layer in a state before being crosslinked, that is, a layer formed from the resin composition for laser engraving of the present invention, which may be dried as necessary.

In the present invention, the ‘crosslinked relief-forming layer’ means a layer formed by crosslinking the relief-forming layer. The crosslinking is preferably carried out by means of heat and/or light.

The ‘relief printing plate’ is prepared by laser engraving a printing plate precursor having a crosslinked relief-forming layer.

Moreover, in the present invention, the ‘relief layer’ means a layer of the relief printing plate formed by engraving using a laser, that is, the crosslinked relief-forming layer after laser engraving.

The relief-forming layer is preferably provided above a support.

The relief printing plate precursor for laser engraving may further comprise, as necessary, an adhesive layer between the support and the relief-forming layer and, above the relief-forming layer, a slip coat layer and a protection film.

### (Relief-Forming Layer)

The relief-forming layer is a layer formed from the resin composition for laser engraving of the present invention, and is preferably a layer that is cured by at least one of light and heat, that is, a layer having crosslinkablility.

As a process for producing a relief printing plate using the relief printing plate precursor of the present invention, it is preferably a process for producing a relief printing plate by crosslinking a relief-forming layer and then carrying out laser engraving to thus form a relief layer. By crosslinking the relief-forming layer, it is possible to prevent abrasion of the relief layer during printing, and it is possible to obtain a relief printing plate having a relief layer with a sharp shape after laser engraving.

In addition, the relief-forming layer may be formed by molding the resin composition for laser engraving into a sheet shape or a sleeve shape.

### (Support)

The support that can be used in the relief printing plate precursor for laser engraving is now explained.

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET) or polybutylene terephthalate (PBT)), polyacrylonitrile (PAN) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

Furthermore, in a relief printing plate precursor for laser engraving prepared by coating a crosslinkable resin composition for laser engraving and curing it from the reverse face (face opposite to the face that is to be subjected to laser engraving, those with a cylindrical shape also being included) by means of heat and/or light, the reverse face of the cured resin composition for laser engraving functions as a support, and a support is therefore not always necessary.

### (Adhesive Layer)

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### (Protection Film, Slip Coat Layer)

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Method for Producing Relief Printing Plate Precursor for Laser Engraving)

Subsequently, the method for producing a relief printing plate precursor for laser engraving (hereinafter, also called “relief printing plate precursor”) will be described.

The method for producing a relief printing plate precursor preferably comprises (1) a layer forming step of applying a resin composition for laser engraving on a support and forming an uncrosslinked relief-forming layer, and a crosslinking step of crosslinking the uncrosslinked relief-forming layer by means of at least one of light and heat, and obtaining a relief printing plate precursor having a relief-forming layer; or (2) a step of applying a resin composition on a film and forming an uncrosslinked relief-forming layer, a layer-forming step of crosslinking the uncrosslinked relief-forming layer by means of at least one of irradiation of active radiation and heating, and obtaining a relief printing plate precursor having a relief-forming layer, and a crosslinking step of curing one of the surfaces of the uncrosslinked relief-forming layer or the relief-forming layer after crosslinking. The method more preferably comprises (1) a layer forming step of applying a resin composition for laser engraving on a support and forming an uncrosslinked relief-forming layer, and a crosslinking step of crosslinking the uncrosslinked relief-forming layer by means of at least one of light and heat, and obtaining a relief printing plate precursor having a relief-forming layer.

Furthermore, the uncrosslinked relief-forming layer thus applied is preferably dried as necessary. Meanwhile, the term “applied” as used in the present invention includes not only the meaning of being provided by coating, but also the meaning of being provided by flow casting.

As the layer forming step, preferred examples of a method for forming a relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove the solvent.

The resin composition for laser engraving may be produced by, for example, dissolving the crosslinking agent, the polymer, and as optional components a photothermal conversion agent and a plasticizer in an appropriate solvent, and then dissolving a polymerizable compound and a polymerization initiator. Since it is necessary to remove most of the solvent component in a stage of producing a relief printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

The thickness of the relief-forming layer in the relief printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

The relief printing plate precursor that can be used in the present invention preferably has a relief-forming layer in a state of being cured by crosslinking, as described above. In order to obtain such a relief-forming layer, it is preferable for the method to comprise a step of crosslinking an uncrosslinked relief-forming layer in the relief printing plate precursor by means of light and/or heat, as a preliminary step.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

When the relief-forming layer comprises a thermopolymerization initiator (it being possible for the above-mentioned photopolymerization initiator to function also as a thermopolymerization initiator), the relief-forming layer may be crosslinked by heating the relief printing plate precursor for laser engraving (step of crosslinking by means of heat). As heating means, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed.

Furthermore, it is particularly preferable that the method for producing a relief printing plate precursor of the present invention comprise a step of applying a resin composition containing at least Component A and Component B on a support, and forming an uncrosslinked relief-forming layer, and a step of crosslinking the uncrosslinked relief-forming layer by means of light and/or heat, and obtaining a relief printing plate precursor having a relief-forming layer.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and azo group-containing compound. A representative vulcanizing agent may also be used for crosslinking. Thermal crosslinking may also be carried out by adding a heat-curable resin such as for example an epoxy resin as a crosslinking component to a layer.

As the method for crosslinking the relief-forming layer in the crosslinking step, crosslinking by heat is preferred from the viewpoint of enabling uniform curing (crosslinking) of the relief-forming layer from the surface to the interior.

When the relief-forming layer is crosslinked, it is advantageous in that firstly, the relief formed after laser engraving becomes sharp, and secondly, the adhesiveness of engraving residue generated at the time of laser engraving is suppressed. When the uncrosslinked relief-forming layer is laser-engraved, there are occasions in which due to the excess heat propagated to the periphery of a laser-irradiated area, originally unintended areas are prone to melting and deformation, and a sharp relief layer may not be obtained. Furthermore, as a general nature of materials, a substance having a lower molecular weight tends to be a liquid rather than a solid, and to have stronger adhesiveness. The engraving residue generated when the relief-forming layer is engraved tends to have stronger adhesiveness as more of a material having a lower molecular weight is used. Since a polymerizable compound having a low molecular weight forms a polymer by being crosslinked, the engraving residue generated tends to have less adhesiveness.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### 3. Relief Printing Plate and Process for Making Same

The process for making a relief printing plate of the present invention comprises a layer formation step of forming a relief-forming layer from the resin composition for laser engraving of the present invention, a crosslinking step of crosslinking the relief-forming layer by means of heat and/or light to thus obtain a relief printing plate precursor having a crosslinked relief-forming layer, and an engraving step of laser-engraving the relief printing plate precursor having the crosslinked relief-forming layer.

The relief printing plate of the present invention is a relief printing plate having a relief layer obtained by crosslinking and laser-engraving a layer formed from the resin composition for laser engraving of the present invention, and is preferably a relief printing plate made by the process for making a relief printing plate of the present invention.

The layer formation step and the crosslinking step in the process for making a relief printing plate of the present invention mean the same as the layer formation step and the crosslinking step in the above-mentioned process for producing a relief printing plate precursor for laser engraving, and preferred ranges are also the same.

### (Engraving Step)

The process for making a relief printing plate of the present invention preferably comprises an engraving step of laser-engraving the relief printing plate precursor having a crosslinked relief-forming layer.

The engraving step preferably forms a relief when laser light corresponding to the image intended to be formed is irradiated by a specific laser that is described below, and forms a relief layer for printing.

Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved.

At this time, since the exposed region generates heat also due to the photothermal conversion agent in the relief-forming layer, the heat generated by this photothermal conversion agent also promotes the removability of the engraving residue.

The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the peak absorption wavelength of the photothermal conversion agent, it becomes possible to selectively remove the crosslinked relief-forming layer at higher sensitivity, thus giving a relief layer having a sharp image.

As the infrared laser used in engraving, from the viewpoint of productivity, cost, etc., a carbon dioxide laser or a semiconductor laser, which is described in detail below, is preferable.

In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber. Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate producing equipment comprising a fiber-coupled semiconductor laser that can be used suitably in the process for producing a relief printing plate employing the relief printing plate precursor of the present invention, those described in detail in JP-A-2009-172658 and JP-A-2009-214334 can be cited. Such equipment comprising a fiber-coupled semiconductor laser can be used to produce a relief printing plate of the present invention.

With regard to the semiconductor laser used for laser engraving, one having a wavelength of 700 to 1,300 nm is preferable, one having a wavelength of 800 to 1,200 nm is more preferable, one having a wavelength of 860 to 1,200 nm is further preferable, and one having a wavelength of 900 to 1,100 nm is particularly preferable.

Since the band gap of GaAs is 860 nm at room temperature, in the region of less than 860 nm, generally, an AlGaAs-based active layer is preferably used. On the other hand, in the region of 860 nm or greater, an InGaAs-based semiconductor active layer material is used. Generally, since Al is easily oxidized, a semiconductor laser having an InGaAs-based material in the active layer has higher reliability than an AlGaAs-based material, and a semiconductor laser having a wavelength of 860 nm to 1,200 nm is preferred.

Furthermore, as a practical semiconductor laser, when the compositions of not only the active layer material but also the clad material are considered, in a semiconductor laser having an InGaAs-based material in the active layer according to a more preferable embodiment, a semiconductor laser having higher reliability with a higher power output is likely to be obtained in a wavelength range of 900 nm to 1,100 nm. Therefore, when a fiber-coupled semiconductor laser having an InGaAs-based material having a wavelength of 900 nm to 1,100 nm in the active layer is used, low cost and high productivity may be easily achieved.

In order to realize an inexpensive laser-engraving relief printing system with low cost, high productivity and satisfactory image quality, it is preferable to use a relief printing plate precursor including a relief-forming layer which uses a resin composition for laser engraving that will be described below, and to use a semiconductor laser, particularly a fiber-coupled semiconductor laser, having a specific wavelength as described above.

When a fiber-coupled semiconductor laser is used, it is also advantageous in that for the control of the shape intended to be engraved, the shape of the engraved region can be changed by changing the beam shape of the fiber-coupled semiconductor laser, or by changing the amount of energy supplied to the laser without changing the beam shape.

The process for producing a relief printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid containing water as a main component.

Drying step: a step of drying the engraved relief layer.

Post-crosslinking step: a step of further crosslinking the relief layer by applying energy to the engraved relief layer.

The rinsing step of washing off engraving residue by rinsing the engraved surface with water or a liquid containing water as a main component may be added. Examples of rinsing means include a method in which washing is carried out with tap water or rinsing liquid, a method in which high pressure water or high pressure rinsing liquid is spray-jetted, and a method in which the engraved surface is brushed in the presence of mainly water or rinsing liquid using a batch or conveyor brush type washout machine known as a photosensitive resin letterpress plate processor.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

As the rinsing liquid that can be used in the present invention, water, or a liquid containing water as a main component is preferred.

The use amount of the rinsing liquid is such that at least the entire plate needs to be covered by the liquid. The use amount may vary with the plate, but the use amount is preferably 10 cc/m² or greater, more preferably 50 cc/m² or greater, and yet more preferably 70 cc/m² or greater. Furthermore, the use amount of the rinsing liquid is particularly preferably 70 cc/m² to 500 cc/m², from the viewpoint of the cost of the liquid throughput.

The rinsing liquid that can be used in the present invention preferably comprises water as a main component.

The rinsing liquid may contain as a solvent other than water a water-miscible solvent such as an alcohol, acetone, or tetrahydrofuran.

The pH of the rinsing liquid is preferably at least 9, more preferably at least 10, and yet more preferably at least 11. The pH of the rinsing liquid is preferably no greater than 14, more preferably no greater than 13, and yet more preferably no greater than 12.5. When in the above-mentioned range, sufficient rinsing properties (washing properties) are obtained, and handling is easy.

The rinsing liquid for the relief printing plate making of the present invention preferably comprises a basic compound, and more preferably a water-soluble basic compound.

The basic compound is not particularly limited; a known basic compound may be used, an inorganic basic compound is preferable, an alkali metal salt compound and an alkaline earth metal salt compound are more preferable, and an alkali metal hydroxide is yet more preferable.

Examples of the basic compound include inorganic alkali salts such as sodium hydroxide, ammonium hydroxide, potassium hydroxide, lithium hydroxide, sodium silicate, potassium silicate, trisodium phosphate, tripotassium phosphate, triammonium phosphate, disodium phosphate, dipotassium phosphate, diammonium phosphate, sodium carbonate, potassium carbonate, ammonium carbonate, sodium bicarbonate, potassium bicarbonate, ammonium bicarbonate, sodium borate, potassium borate, and ammonium borate.

Furthermore, when an acid is used for adjusting the pH, an inorganic acid is preferable, and examples thereof include hydrochloric acid, sulfuric acid, phosphoric acid, and nitric acid.

The rinsing liquid preferably comprises a surfactant.

The surfactant is not particularly limited; a known surfactant may be used, and examples thereof include an anionic surfactant, a cationic surfactant, an amphoteric surfactant, and a nonionic surfactant.

Examples of the anionic surfactant include a fatty acid salt, an abietate, a hydroxyalkanesulfonate, an alkanesulfonate, an α-olefinsulfonate, a dialkylsulfosuccinate, an alkyl diphenyl ether disulfonate, a straight chain alkylbenzenesulfonate, a branched chain alkylbenzenesulfonate, an alkylnaphthalenesulfonate, an alkylphenoxypolyoxyethylenepropylsulfonate, a polyoxyethylene alkyl sulfophenyl ether, a sodium N-methyl-N-oleyltaurate, an N-alkylsulfosuccinic acid monoamide disodium salt, a petroleum sulfonate, sulfated castor oil, sulfated tallow oil, a fatty acid alkyl ester sulfate ester salt, an alkylsulfate ester salt, a polyoxyethylene alkyl ether sulfate ester salt, a fatty acid monoglyceride sulfate ester salt, a polyoxyethylene alkyl phenyl ether sulfate ester salt, a polyoxyethylene styryl phenyl ether sulfate ester salt, an alkylphosphate ester salt, a polyoxyethylene alkyl ether phosphate ester salt, a polyoxyethylene alkyl phenyl ether phosphate ester salt, a partially saponified styrene maleic anhydride copolymer, a partially saponified olefin-maleic anhydride copolymer, and a naphthalenesulfonate formalin condensate.

Examples of the cationic surfactant include an alkylamine salt and a quaternary ammonium salt.

Examples of the amphoteric surfactant include an alkylcarboxybetaine, an alkylimidazoline, and an alkylaminocarboxylic acid.

Examples of the nonionic surfactant include a polyoxyethylene alkyl ether, a polyoxyethylene alkyl phenyl ether, polyoxyethylene polystyryl phenyl ether, polyoxyethylene polyoxypropylene alkyl ether, a glycerol fatty acid partial ester, a sorbitan fatty acid partial ester, a pentaerythritol fatty acid partial ester, propylene glycol monofatty acid ester, sucrose fatty acid partial ester, a polyoxyethylene sorbitan fatty acid partial ester, a polyoxyethylene sorbitol fatty acid partial ester, a polyethylene glycol fatty acid ester, a polyglycerol fatty acid partial ester, a fatty acid diethanolamide, an N,N-bis-2-hydroxyalkylamine, polyoxyethylene alkylamine, triethanolamine fatty acid ester, trialkylamine oxide, polypropylene glycol having a molecular weight of 200 to 5,000, trimethylolpropane, a glycerol or sorbitol polyoxyethylene or polyoxypropylene adduct, and an acetylene glycol system.

Furthermore, the surfactant that can be used in the present invention is preferably a carboxybetaine compound, a sulfobetaine compound, a phosphobetaine compound, an amine oxide compound, or a phosphine oxide compound.

Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

The rinsing liquid preferably comprises an antifoaming agent.

As the antifoaming agent, a compound such as a usual silicone-based self-emuslifying type or emulsifying type, or a nonionic surfactant having an HLB (Hydrophile-Lipophile Balance) value of no greater than 5 may be used. A silicone antifoaming agent is preferable. Among them, any of an emulsion-dispersing type, a solubilization type, etc. may be used.

Specific examples of the antifoaming agent include TSA731 and TSA739 (both from Dow Corning Toray).

The content of the antifoaming agent is preferably 0.001 to 1.0 wt % of the rinsing liquid for relief printing plate making.

The relief printing plate of the present invention having a relief layer may be produced as described above.

From the viewpoint of satisfying suitability for various aspects of flexographic printing, such as abrasion resistance and ink transfer properties, the thickness of the relief layer of the relief printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 23° C., 50% RH so as to deform it, measures the amount of deformation (indentation depth), and converts it into a numerical value.

A relief printing plate produced by the process for producing a relief printing plate of the present invention can be applied to printing by a letterpress printer using an oil-based ink or a UV ink as well as printing by a flexographic printer using a UV ink.

According to the present invention, a relief printing plate precursor for laser engraving having excellent solvent resistance, and a resin composition for laser engraving which can yield the relief printing plate precursor for laser engraving are provided. Furthermore, according to the present invention, a method for producing a relief printing plate precursor for laser engraving, a method for making a relief printing plate, and a relief printing plate are provided.

### EXAMPLES

The present invention is explained in further detail below by reference to Examples, but the present invention should not be construed as being limited to the Examples. Furthermore, in the Examples and Comparative Examples below, ‘parts’ means ‘parts by weight’ and “%” means “% by weight”, unless otherwise specified.

### Synthesis Example 1

In a three-necked flask equipped with a stirring blade and a cooling tube, 18.68 parts of 3-aminopropyltriethoxysilane (manufactured by Tokyo Chemical Industry Co., Ltd.) and 7.50 parts of 2-butanone (manufactured by Wako Pure Chemical Industries, Ltd.) were introduced, and 33.7 parts of BLENMER PME-400 (manufactured by NOF Corp.) was added dropwise to the mixture over 30 minutes at room temperature. After the dropwise addition, the temperature was increased to 70° C., and the mixture was stirred for 4 hours. Subsequently, 2-butanone was removed under reduced pressure, and thus (Component A) Compound (1-1) (52.32 parts) was obtained. The structure of (Component A) Compound (1-1) thus obtained was identified by ¹H NMR.

### Synthesis Example (2)

Compound (1-3) was obtained in the same manner as in Synthesis Example (1), except that 16.9 parts of BLENMER PME-200 (manufactured by NOF Corp.) was used instead of 33.7 parts of BLENMER PME-400 (manufactured by NOF Corp.) used in Synthesis Example (1).

### Synthesis Example (3)

Compound (1-1) obtained in Synthesis Example (1) was heated in isopropanol for 1 hour at 100° C., the solvent was distilled off, and thus Compound (1-4) was obtained.

### Synthesis Example (4)

Compound (1-6) was obtained in the same manner as in Synthesis Example (1), except that 20.11 parts by weight of 3-mercaptopropyltriethoxysilane was used instead of 18.68 parts of 3-aminopropyltriethoxysilane (manufactured by Tokyo Chemical Industry Co., Ltd.) used in Synthesis Example (1).

### Synthesis Example (5)

In a three-necked flask equipped with a stirring blade and a cooling tube, 23.43 parts of acryloxypropyltriethoxysilane (manufactured by Tokyo Chemical Industry Co., Ltd.) and 7.50 parts of 2-butanone (manufactured by Wako Pure Chemical Industries, Ltd.) were introduced, and 42.85 parts of nonaethyleneglycol monomethylether (manufactured by Tokyo Chemical Industry Co., Ltd.) was added dropwise to the mixture over 30 minutes at room temperature. After the dropwise addition, the temperature was increased to 70° C., and the mixture was stirred for 4 hours. Subsequently, 2-butanone was removed under reduced pressure, and thus Compound (1-8) (66.12 parts) was obtained. The structure of Compound (1-8) thus obtained was identified by ¹H NMR.

### Synthesis Example (6)

42.8 parts of nonaethylene glycol monomethyl ether (manufactured by Tokyo Chemical Industry Co., Ltd.), 9.52 parts of chloroacetone (manufactured by Tokyo Chemical Industry Co., Ltd.), 0.7 parts of triethylamine (manufactured by Tokyo Chemical Industry Co., Ltd.), and 80 parts of 2-butanone (manufactured by Wako Pure Chemical Industries, Ltd.) were stirred for 12 hours, and then 20 parts of water was added to perform washing. The organic solvent fraction was separated, and 2-butanone was removed under reduced pressure. Subsequently, 22.1 parts of 3-aminopropyltriethoxysilane (manufactured by Tokyo Chemical Industry Co., Ltd.) and 60 parts of ethanol were added thereto, and the mixture was stirred again for 12 hours. Subsequently, ethanol was removed under reduced pressure, and thus 65.7 parts of Compound (1-18) was obtained.

### Example 1

### Production of Relief-Forming Layer

In a three-necked flask equipped with a stirring blade and a cooling tube, 50 parts of “DENKA BUTYRAL #3000-2” (manufactured by Denki Kagaku Kogyo K.K., polyvinyl butyral derivative Mw=90,000) as Component B, and 47 parts of propylene glycol monomethyl ether acetate as a solvent were introduced, and while being stirred, the mixture was heated at 70° C. for 120 minutes to dissolve the polymer. Subsequently, the solution was adjusted to 40° C., and was stirred for 30 minutes. Thereafter, 15 parts of Monomer (M-1) (having the following structure) as (Component F) a polymerizable compound (polyfunctional substance), 4 parts of BLENMER LMA (manufactured by NOF Corp.) as a polymerizable compound (monofunctional substance: lauryl methacrylate), 1.0 part of t-butyl peroxybenzoate (trade name: PERBUTYL Z, manufactured by NOF Corp.) as (Component G) a polymerization initiator, 30 parts of Compound (1-8) (having the structure described above) as Component A, and 0.4 parts of phosphoric acid as (Component E) an alcohol exchange reaction catalyst were added to the solution, and the mixture was stirred for 10 minutes at 40° C. Through this operation, a coating liquid 1 for crosslinkable relief-forming layer having fluidity (crosslinkable resin composition 1 for laser engraving) was obtained.

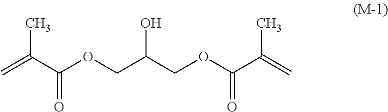 [SMILES: C=C(C)C(=O)OCC(O)COC(=O)C(=C)C]

### 2. Production of Relief Printing Plate Precursor for Laser Engraving

A spacer (frame) having a predetermined thickness was provided on a PET substrate, and the coating liquid 1 for crosslinkable relief-forming layer obtained as described above was gently flow cast thereon to the extent that the coating liquid would not flow out over the space (frame). The coating liquid was dried for 3 hours in an oven at 70° C., and thus a relief-forming layer having a thickness of approximately 1 mm was provided. Thus, a relief printing plate precursor 1 for laser engraving was produced.

### Examples 2 to 6 and 8, and Comparative Examples 1, 3 and 4

Relief printing plate precursors were produced in the same manner as in Example 1, except that Component A and Component B were changed to the compounds described in the table.

### Example 7

### Production of Relief-Forming Layer

In a three-necked flask equipped with a stirring blade and a cooling tube, 50 parts of “DENKA BUTYRAL #3000-2” (manufactured by Denki Kagaku Kogyo K.K., polyvinyl butyral derivative Mw=90,000) as Component B, and 47 parts of propylene glycol monomethyl ether acetate as a solvent were introduced, and while being stirred, the mixture was heated at 70° C. for 120 minutes to dissolve the polymer. Subsequently, the solution was adjusted to 40° C., and was stirred for 30 minutes. Thereafter, 20 parts of Compound (S-1) (the structure is shown below; available from Shin-Etsu Chemical Co., Ltd. under trade name: KBE-846) as Component C, 30 parts of Compound (1-8) (having the structure described above) as Component A, and 0.4 parts of phosphoric acid as (Component E) an alcohol exchange reaction catalyst were added to the solution, and the mixture was stirred for 10 minutes at 40° C. Through this operation, a coating liquid for crosslinkable relief-forming layer having fluidity (crosslinkable resin composition for laser engraving) was obtained. A relief printing plate precursor was produced in the same manner as in Example 1.

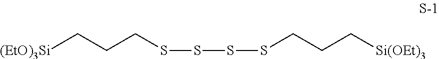

### Example 9

A relief printing plate precursor was produced in the same manner as in Example 1, except that Component A and Component B of Example 1 were changed to the compounds described in the table, and 1.0 part of Ketjenblack EC600JD (carbon black, DBP oil absorption: 495 ml/100 g, BET specific surface area: 1,270 m²/g, manufactured by Lion Corp.) was added as (Component D) a photothermal conversion agent.

### Comparative Example 2

A relief printing plate precursor 10 for laser engraving was produced in the same manner as in Example 1, except that 30 parts of didodecyl phthalate was used as a plasticizer instead of Compound (1-8) used in Example 1.

The relief-forming layer after crosslinking was engraved with the following two kinds of lasers, and thus relief printing plates were obtained.

For the engraving by laser irradiation with a carbon dioxide laser engraving machine, high-resolution CO₂ laser marker ML-9100 series (manufactured by Keyence Corp.) was used. A solid area which measured 1 cm on each of four sides was raster-engraved with the carbon dioxide laser engraving machine under the conditions of a power output of 12 W, a head speed of 200 mm/sec, and a pitch of 2,400 DPI.

As a semiconductor laser engraving machine, a laser recording apparatus equipped with a fiber-coupled semiconductor laser (FC-LD) SDL-6390 (manufactured by JDSU Corp., wavelength: 915 nm) having a maximum power output of 8.0 W was used. A solid area which measured 1 cm on each of four sides was raster-engraved with the semiconductor laser engraving machine under the conditions of a laser power output of 7.5 W, a head speed of 409 mm/sec, and a pitch of 2,400 DPI.

### (Evaluation)

### <Measurement of Glass Transition Temperature>

The glass transition temperature (Tg) of the crosslinked relief-forming layer was measured with a viscoelasticity analyzer (Rheogel-E4000). The value of temperature at which tan δ became the maximum when the temperature in the range of −10° C. to 50° C. was changed at a rate of 1° C. per minute, was defined as Tg.

### <Solvent Resistance>

A relief printing plate precursor having a crosslinked relief-forming layer was immersed in butyl acetate, and after 24 hours, the relief printing plate precursor was heated for 1 hour at 100° C. The mass change after the heating was measured.

A sample with a mass change of 3% or less was rated as A; a sample with a mass change of greater than 3% and less than or equal to 5% was rated as B; a sample with a mass change of greater than 5% and less than or equal to 10% was rated as C; a sample with a mass change of greater than 10% and less than or equal to 30% was rated as D; and a sample with a mass change of greater than 30% was rated as E.

### <Evaluation of Bleeding: Paper Dust Attachment Test>

The evaluation of bleeding was carried out by a paper dust attachment test. 5 g of paper dust was loaded on 25 cm² of a flexographic printing plate precursor having a crosslinked relief-forming layer and was left to stand for 1 hour. Subsequently, the paper dust was allowed to drop off, and the weight change was evaluated. A sample with a weight change of 0.10 g or less was rated as A; a sample with a weight change of greater than 0.10 g and less than or equal to 0.15 g was rated as B; and a sample with a weight change of greater than 0.15 g was rated as C.

### <Shore A Hardness>

The Shore A hardness was measured with a DUROMETER (spring type rubber hardness meter) which presses an indenter into the surface of an object of measurement at 23° C. and 50% RH to deform the surface, measures the amount of deformation (depth of insertion), and converts the data to numerical values.

The results are shown in the following table.

TABLE 2

| | Component A | | | | Content of | Evaluation | | | |
|---|---|---|---|---|---|---|---|---|---|
| | | State | Content | | plasticizer | Solvent | Paper dust | | Shore A |
| | Type | at 25° C. | (wt %) | Component B | (wt %) | resistance | adherence | Tg | hardness |
| Example 1 | (1-8) | Liquid | 30% | PVB | 0% | B | A | 20° C. | 75° |
| Example 2 | (1-4) | Liquid | 30% | PVB | 0% | C | A | 10° C. | 74° |
| Example 3 | (1-18) | Solid | 30% | PVB | 0% | C | A | 20° C. | 80° |
| Example 4 | (1-1) | Liquid | 30% | PVB | 0% | B | A | 15° C. | 80° |
| Example 5 | (1-1) | Liquid | 30% | POLYMENT | 0% | B | A | 15° C. | 79° |
| | | | | NK-350 | | | | | |
| Example 6 | (1-3) | Liquid | 30% | PVB | 0% | A | A | 15° C. | 73° |
| Example 7 | (1-8) | Liquid | 30% | PVB | 0% | A | A | 20° C. | 77° |
| Example 8 | (1-6) | Liquid | 30% | PVB | 0% | A | A | 15° C. | 76° |
| Example 9 | (1-1) | Liquid | 30% | PVB | 0% | B | A | 20° C. | 83° |
| Comparative | BLENMER | Liquid | 30% | PVB | 0% | D | C | 10° C. | 79° |
| Example 1 | PME1000 | | | | | | | | |
| Comparative | None | — | 0% | PVB | 30% | E | A | 15° C. | 85° |
| Example 2 | | | | | | | | | |
| Comparative | None | — | 0% | PVB | 0% | E | A | Room temperature | 86° |
| Example 3 | | | | | | | | or higher | |
| Comparative | (1-1) | Liquid | 30% | PMMA | 0% | D | C | 15° C. | 71° |
| Example 4 | | | | | | | | | |

Components used in Table 2 are shown below.
BLENMER PME1000: Methoxypolyethylene glycol monomethacrylate manufactured by NOF Corp.
POLYMENT NK-350: Aminomethylated acrylic polymer, manufactured by Nippon Shokubai Co., Ltd.

What is claimed is:

1. A resin composition for laser engraving comprising:
(Component A) a compound represented by following Formula (1), and
(Component B) a binder polymer having a functional group that is capable of reacting with a hydrolyzable silyl group and/or a silanol group and thereby forming a crosslinked structure: 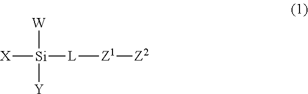
wherein in Formula (1), W, X and Y each independently represent a hydrolyzable group selected from the group consisting of an alkoxy group, an aryloxy group, a mercapto group, a halogen atom, an amide group, an acetoxy group, an amino group and an isopropenoxy group, or a hydroxy group; L represents a divalent linking group or a single bond; Z¹ represents a divalent group having 4 to 45 carbon atoms in total and containing at least two of a unit selected from an ethylene oxide unit and a propylene oxide unit; Z² represents an alkyl group having 7 or less carbon atoms, or a benzyl group; and the sum of the numbers of carbon atoms of L, Z¹ and Z² is 10 to 50.

2. The resin composition for laser engraving according to claim 1, wherein the melting point at 1 atm of the compound represented by Formula (1) is 25° C. or less.

3. The resin composition for laser engraving according to claim 1, wherein in Formula (1), L represents a divalent linking group having, in the structure, at least one selected from the group consisting of an ester bond, a thioester bond, a thionoester bond, an amide bond, a carbonyl group, a thiocarbonyl group, an ether bond, a thioether bond, —NR¹— (wherein R¹ represents a hydrogen atom, or an alkyl group having 1 to 4 carbon atoms), and —N═CR²— (wherein R² represents a hydrogen atom or an alkyl group having 1 to 4 carbon atoms).

4. The resin composition for laser engraving according to claim 1, wherein in Formula (1), L represents a divalent linking group having, in the structure, at least one selected from the group consisting of an ester bond, a thioester bond, a thionoester bond, an amide bond, a carbonyl group, and a thiocarbonyl group, and at least one selected from the group consisting of an ether bond, a thioether bond, —NR¹— (wherein R¹ represents a hydrogen atom or an alkyl group having 1 to 4 carbon atoms), and —N═CR²— (wherein R² represents a hydrogen atom or an alkyl group having 1 to 4 carbon atoms).

5. The resin composition for laser engraving according to claim 1, wherein in Formula (1), L represents L¹-L²-L³; L¹ represents an alkylene group or a divalent linking group having at least one selected from the group consisting of —O—, —S—, —NR¹— (wherein R¹ represents a hydrogen atom or an alkyl group having 1 to 4 carbon atoms), and —N═CR²— (wherein R² represents a hydrogen atom or an alkyl group having 1 to 4 carbon atoms); L² represents a divalent linking group having at least one selected from the group consisting of an ester bond, a thioester bond, a thionoester bond, an amide bond, a carbonyl group, and a thiocarbonyl group; and L³ represents a single bond or a group selected from the group consisting of a methylene group, an ethylene group and a propylene group.

6. The resin composition for laser engraving according to claim 1 wherein Component A has a content of 10 wt % to 40 wt % relative to the weight of the solids content of the resin composition for laser engraving.

7. The resin composition for laser engraving according to claim 1, further comprising (Component C) a silane coupling agent.

8. The resin composition for laser engraving according to claim 1, further comprising (Component D) a photothermal conversion agent.

9. The resin composition for laser engraving according to claim 1, wherein the functional group that is capable of reacting with a hydrolyzable silyl group and/or a silanol group and forming a crosslinked structure in (Component B) the binder polymer, is selected from the group consisting of a hydroxy group, an alkoxy group, a silanol group, and a hydrolyzable silyl group.

10. The resin composition for laser engraving according to claim 1, wherein (Component B) the binder polymer is an acrylic resin and/or polyvinyl butyral.

11. The resin composition for laser engraving according to claim 1, further comprising (Component E) an alcohol exchange reaction catalyst.

12. The resin composition for laser engraving according to claim 1, further comprising: (Component F) a polymerizable compound; and (Component G) a polymerization initiator.

13. A relief printing plate precursor for laser engraving, comprising a relief-forming layer formed from the resin composition for laser engraving according to claim 1.

14. A relief printing plate precursor for laser engraving, comprising a crosslinked relief-forming layer formed by crosslinking a relief-forming layer formed from the resin composition for laser engraving according to claim 1, by means of light and/or heat.

15. A method for producing a relief printing plate precursor for laser engraving, the method comprising:
a layer forming step of forming a relief-forming layer formed from the resin composition for laser engraving according to claim 1; and
a crosslinking step of crosslinking the relief-forming layer by means of light and/or heat to obtain a relief printing plate precursor having a crosslinked relief-forming layer.

16. The method for producing a relief printing plate precursor for laser engraving according to claim 15, wherein the crosslinking step is a step of crosslinking a layer of the resin composition for laser engraving by means of heat, and thereby obtaining a relief printing plate precursor having a crosslinked relief-forming layer.

17. A method for making a relief printing plate, the method comprising:
a step of obtaining a relief printing plate precursor having a crosslinked relief-forming layer that is obtainable by crosslinking a relief-forming layer formed from the resin composition for laser engraving according to claim 1 by means of light and/or heat; and
a step of laser-engraving the crosslinked relief-forming layer of the relief printing plate precursor.

18. A relief printing plate comprising a relief layer made by the method for making a relief printing plate according to claim 17.

19. The relief printing plate according to claim 18, wherein the thickness of the relief layer is at least 0.05 mm but no greater than 10 mm.

20. The relief printing plate according to claim 18, wherein the Shore A hardness of the relief layer is at least 50° but not greater than 90°.
